(19) United States
(12) Patent Application Publication
(10) Pub. No.: US 2023/0308458 A1
(43) Pub. Date: Sep. 28, 2023

(54) STRUCTURED DATA DISCOVERY AND CRYPTOGRAPHIC ANALYSIS

(71) Applicant: IPIVOT, CORP., Valley Center, CA (US)

(72) Inventors: Eric Varsanyi, Minneapolis, MN (US); Brett Helm, Poway, CA (US)

(21) Appl. No.: 18/018,794

(22) PCT Filed: Jul. 27, 2021
(86) PCT No.: PCT/US2021/043313

§ 371 Date: Jan. 30, 2023

Related U.S. Application Data
(60) Provisional application No. 63/057,616, filed on Jul. 28, 2020.

(51) Int. Cl. H04L 9/40; H04L 41/02

(52) U.S. Cl. CPC H04L 63/1416; H04L 63/1425; H04L 63/0428; H04L 63/0823; H04L 41/024

(57) ABSTRACT

Structured Data Discovery and Cryptographic Analysis. In an embodiment, transport sessions are assembled from raw packets captured in network traffic. Data is extracted from two or more encapsulation layers of each transport session. In particular, each encapsulation layer may be classified into a protocol, and data may be extracted from the encapsulation layer based on the protocol. For example, cryptographic metadata may be extracted from a cryptographic encapsulation layer. The extracted data is incorporated into a data model of the network, which comprises tallies of traffic within the network, grouped according to a plurality of dimensions. Analytic model(s) may be applied to the data model to, for example, generate a data web of the network that represents structured data stores and data flows to and/or from the data stores within the network.

### CROSS-REFERENCE TO RELATED APPLICATIONS

This application claims priority to U.S. Provisional Patent App. No. 63/057,616, filed on Jul. 28, 2020, which is hereby incorporated herein by reference as if set forth in full.

This application is related to U.S. Pat. No. 9,100,291 (“the '291 patent”), titled “Systems and Methods for Extracting Structured Application Data from a Communications Link” and issued on Aug. 4, 2015, U.S. Pat. No. 9,185,125 (“the '125 patent”), titled “Systems and Methods for Detecting and Mitigating Threats to a Structured Data Storage System” and issued on Nov. 10, 2015, and U.S. Pat. No. 9,525,642 (“the '642 patent”), titled “Ordering Traffic Captured on a Data Connection” and issued on Dec. 20, 2016, which are all hereby incorporated herein by reference as if set forth in full.

### BACKGROUND

### Field of the Invention

The embodiments described herein are generally directed to network security and management, and, more particularly, to structured data discovery and cryptographic analysis.

### Description of the Related Art

Raw network traffic, observed within the network fabric or at network endpoints, can be analyzed to generate annotated network flows, representing the flows of data through a network. It would be beneficial to identify the application-level meaning of these traffic flows and correlate these traffic flows with data stores. However, currently such identification has been limited to the identification of unstructured data sources and unstructured data sinks. In addition, conventional analytic systems require existing knowledge about the endpoints in a network and are incapable of independently validating trust of encrypted connections on the network.

### SUMMARY

Accordingly, systems, methods, and non-transitory computer-readable media are disclosed for structured data discovery and cryptographic analysis.

In an embodiment, a method is disclosed that comprises using at least one hardware processor to: receive a plurality of transport sessions that have been assembled from captured raw packets being transmitted in a network; for each of the plurality of transport sessions, extract data from each of two or more encapsulation layers in a payload of the transport session; incorporate the extracted data into a data model of the network, wherein the data model comprises tallies of traffic within the network grouped according to a plurality of dimensions; and apply one or more analytic models to the data model, wherein at least one of the one or more analytic models utilizes the tallies of traffic to identify structured data stores within the network. Extracting data from each of two or more encapsulation layers may comprise, for each of the two or more encapsulation layers: classifying the encapsulation layer into a protocol; and extracting the data from the encapsulation layer based on the protocol.

When the protocol is a cryptographic protocol, extracting the data from the encapsulation layer may comprise extracting cryptographic metadata from the encapsulation layer. The cryptographic metadata may comprise a certificate. The cryptographic metadata may comprise one or more cryptographic parameters. The cryptographic metadata may be extracted from a handshake of the cryptographic protocol.

One of the two or more encapsulation layers may be nested within another one of the two or more encapsulation layers, and classification of each encapsulation layer into a protocol may be performed recursively.

Classifying the encapsulation layer into a protocol may comprise: executing a plurality of plugins that each represent one of a plurality of protocols, wherein each of the plurality of plugins is configured to analyze one or more characteristics of data in the encapsulation layer to determine whether or not the encapsulation layer matches the represented protocol; and determining the protocol into which the encapsulation layer is classified based on the determinations by the plurality of plugins. Analyzing one or more characteristics of data in the encapsulation layer may comprise parsing messages in a message stream encapsulated by the encapsulation layer according to a state machine to determine whether or not the messages represent a sequence of operations that is specific to the represented protocol.

Extracting data from each of two or more encapsulation layers may comprise, for each of the two or more encapsulation layers, if classification of the encapsulation layer into a protocol fails, sending the encapsulation layer to a metrics process that collects one or more measurements.

Each of the tallies of traffic may indicate an amount of traffic.

Incorporating the extracted data into the data model may comprise folding the extracted data into the data model according to the plurality of dimensions, wherein one of the plurality of dimensions is a time bucket representing a time span.

The data model may represent objects in the network as data structures. The data structure that represents at least one object may comprise an unsure parameter that indicates whether or not a datum in the data structure that represents the at least one object has been inferred.

At least a subset of the tallies of traffic may represent an event. The event may be a database operation. The database operation may be a Structured Query Language (SQL) statement or a remote procedure call (RPC).

The one or more analytic models may be applied to the data model in real time to detect an attack in progress within at least one of the plurality of transport sessions, and the method may further comprise using the at least one hardware processor to block or redirect the attack.

The one or more analytic models may be applied to the data model in real time to detect a violation of a network-level policy within a connection of at least one of the plurality of transport sessions, and the method may further comprise using the at least one hardware processor to block or proxy the connection.

The method may further comprise using the at least one hardware processor to generate a data web that represents the identified structured data stores and data flow to or from the identified structured data stores.

In an embodiment, a method is disclosed that comprises using at least one hardware processor to: receive a plurality of transport sessions that have been assembled from captured raw packets being transmitted in a network; for each of the plurality of transport sessions, for a cryptographic encapsulation layer, classify the cryptographic encapsulation layer into a cryptographic protocol, and extract cryptographic metadata from the cryptographic encapsulation layer, wherein the cryptographic metadata comprises at least one of a certificate or one or more cryptographic parameters, and, for at least one nested encapsulation layer that is encapsulated within the cryptographic encapsulation layer, classify the nested encapsulation layer, and extract data from the nested encapsulation layer; incorporate the extracted cryptographic metadata from the cryptographic encapsulation layer and the extracted data from the nested encapsulation layer into a data model of the network, wherein the data model comprises tallies of traffic within the network grouped according to a plurality of dimensions; apply one or more analytic models to the data model, wherein at least one of the one or more analytic models utilizes the tallies of traffic to identify structured data stores within the network; and generate a data web that represents the identified structured data stores and data flow to or from the identified data stores.

Any of the methods described herein may be embodied in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example processing system, by which one or more of the processes described herein, may be executed, according to an embodiment;

FIG. 2 illustrates an example infrastructure in which one or more of the disclosed processes may be implemented, according to an embodiment;

FIG. 3 illustrates an example data flow in a process for structured data discovery and cryptographic analysis, according to an embodiment; and

FIG. 4 illustrates recursive classification an disposition of encapsulation layers, according to an embodiment.

### DETAILED DESCRIPTION

In an embodiment, systems, methods, and non-transitory computer-readable media are disclosed for structured data discovery and cryptographic analysis. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. System Overview

1.1. Example Processing System

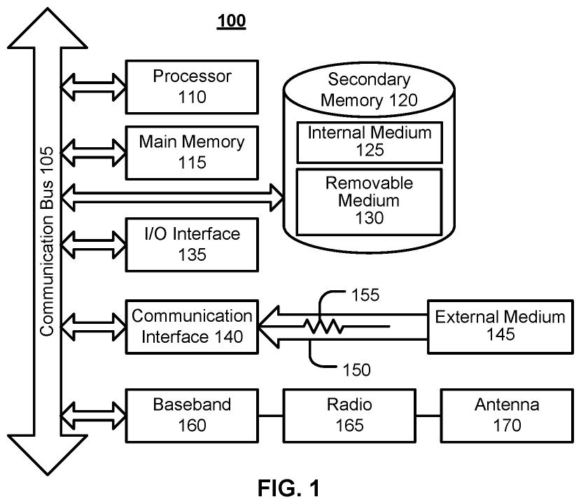

FIG. 1 is a block diagram illustrating an example wired or wireless system 100 that may be used in connection with various embodiments described herein. For example, system 100 may be used as or in conjunction with one or more of the functions, processes, or methods (e.g., to store and/or execute one or more software modules) described herein. System 100 can be a sensor (e.g., low-power sensor), server, conventional personal computer, or any other processor-enabled device that is capable of wired or wireless data communication. Other computer systems and/or architectures may be also used, as will be clear to those skilled in the art.

System 100 preferably includes one or more processors 110. Processor(s) 110 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 110. Examples of processors which may be used with system 100 include, without limitation, the Pentium® processor, Core i7® processor, and Xeon® processor, all of which are available from Intel Corporation of Santa Clara, California.

Processor 110 is preferably connected to a communication bus 105. Communication bus 105 may include a data channel for facilitating information transfer between storage and other peripheral components of system 100. Furthermore, communication bus 105 may provide a set of signals used for communication with processor 110, including a data bus, address bus, and/or control bus (not shown). Communication bus 105 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 100 preferably includes a main memory 115 and may also include a secondary memory 120. Main memory 115 provides storage of instructions and data for programs executing on processor 110, such as one or more of the functions and/or modules discussed herein. It should be understood that programs stored in the memory and executed by processor 110 may be written and/or compiled according to any suitable language, including without limitation C/C++, Java, JavaScript, Perl, Visual Basic, .NET, and the like. Main memory 115 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 120 may optionally include an internal medium 125 and/or a removable medium 130. Removable medium 130 is read from and/or written to in any well-known manner. Removable storage medium 130 may be, for example, a magnetic tape drive, a compact disc (CD) drive, a digital versatile disc (DVD) drive, other optical drive, a flash memory drive, and/or the like.

Secondary memory 120 is a non-transitory computer-readable medium having computer-executable code (e.g., disclosed software modules) and/or other data stored thereon. The computer software or data stored on secondary memory 120 is read into main memory 115 for execution by processor 110.

In alternative embodiments, secondary memory 120 may include other similar means for allowing computer programs or other data or instructions to be loaded into system 100. Such means may include, for example, a communication interface 140, which allows software and data to be transferred from external storage medium 145 to system 100. Examples of external storage medium 145 may include an external hard disk drive, an external optical drive, an external magneto-optical drive, and/or the like. Other examples of secondary memory 120 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 100 may include a communication interface 140. Communication interface 140 allows software and data to be transferred between system 100 and external devices (e.g. printers), networks, or other information sources. For example, computer software or data may be transferred to system 100, over one or more networks (e.g., including the Internet), from a network server via communication interface 140. Examples of communication interface 140 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 100 with a network or another computing device. Communication interface 140 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 140 are generally in the form of electrical communication signals 155. These signals 155 may be provided to communication interface 140 via a communication channel 150. In an embodiment, communication channel 150 may be a wired or wireless network, or any variety of other communication links. Communication channel 150 carries signals 155 and can be implemented using a variety of wired or wireless communication means including wire or cable, fiber optics, conventional phone line, cellular phone link, wireless data communication link, radio frequency (“RF”) link, or infrared link, just to name a few. In a preferred embodiment, communication channel 150 comprises optical fiber, such as 10G fiber.

Computer-executable code (e.g., computer programs, comprising one or more software modules) is stored in main memory 115 and/or secondary memory 120. Computer-executable code can also be received via communication interface 140 and stored in main memory 115 and/or secondary memory 120. Such computer-executable code, when executed, enable system 100 to perform the various functions of the disclosed embodiments as described elsewhere herein.

In this description, the term “computer-readable medium” is used to refer to any non-transitory computer-readable storage media used to provide computer-executable code and/or other data to or within system 100. Examples of such media include main memory 115, secondary memory 120 (including internal memory 125, removable medium 130, and external storage medium 145), and any peripheral device communicatively coupled with communication interface 140 (including a network information server or other network device). These non-transitory computer-readable media are means for providing executable code, programming instructions, software, and/or other data to system 100.

In an embodiment that is implemented using software, the software may be stored on a computer-readable medium and loaded into system 100 by way of removable medium 130, I/O interface 135, or communication interface 140. In such an embodiment, the software is loaded into system 100 in the form of electrical communication signals 155. The software, when executed by processor 110, preferably causes processor 110 to perform one or more of the processes and functions described elsewhere herein.

In an embodiment, I/O interface 135 provides an interface between one or more components of system 100 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 100 may also include optional wireless communication components that facilitate wireless communication over a voice network and/or a data network. The wireless communication components comprise an antenna system 170, a radio system 165, and a baseband system 160. In system 100, radio frequency (RF) signals are transmitted and received over the air by antenna system 170 under the management of radio system 165. However, it should be understood that the various capture, assembly, classification, and analysis systems described herein do not require wireless communication, and in typical embodiments, will not utilize wireless communications.

In an embodiment, antenna system 170 may comprise one or more antennae and one or more multiplexors (not shown) that perform a switching function to provide antenna system 170 with transmit and receive signal paths. In the receive path, received RF signals can be coupled from a multiplexor to a low noise amplifier (not shown) that amplifies the received RF signal and sends the amplified signal to radio system 165.

In an alternative embodiment, radio system 165 may comprise one or more radios that are configured to communicate over various frequencies. In an embodiment, radio system 165 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 165 to baseband system 160.

If the received signal contains audio information, then baseband system 160 decodes the signal and converts it to an analog signal. Then the signal is amplified and sent to a speaker. Baseband system 160 also receives analog audio signals from a microphone. These analog audio signals are converted to digital signals and encoded by baseband system 160. Baseband system 160 also encodes the digital signals for transmission and generates a baseband transmit audio signal that is routed to the modulator portion of radio system 165. The modulator mixes the baseband transmit audio signal with an RF carrier signal, generating an RF transmit signal that is routed to antenna system 170 and may pass through a power amplifier (not shown). The power amplifier amplifies the RF transmit signal and routes it to antenna system 170, where the signal is switched to the antenna port for transmission.

Baseband system 160 is also communicatively coupled with processor(s) 110. Processor(s) 110 may have access to data storage areas 115 and 120. Processor(s) 110 are preferably configured to execute instructions (i.e., computer programs, such as the disclosed application, or software modules) that can be stored in main memory 115 or secondary memory 120. Computer programs can also be received from baseband processor 160 and stored in main memory 110 or in secondary memory 120, or executed upon receipt. Such computer programs, when executed, enable system 100 to perform the various functions of the disclosed embodiments.

1.2. Example Infrastructure

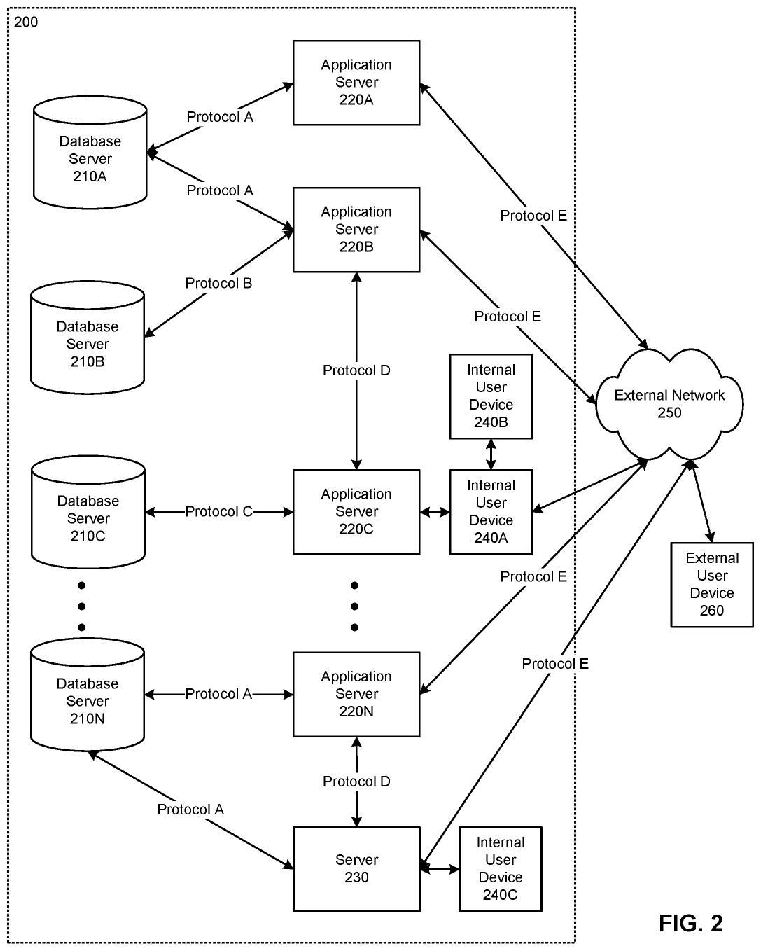

FIG. 2 illustrates an example infrastructure in which one or more of the disclosed processes may be implemented, according to an embodiment. As illustrated, the infrastructure may comprise a network 200 that comprises one or a plurality of database server(s) 210 and one or a plurality of application servers 220. Some of the application server(s) 220 may communicate with one or more database servers 210 and/or an external network 250. One or more internal user devices 240 may interact within network 200 with one or more application servers 220, and one or more external user devices 340 may interact via external network 250 with one or more application servers within network 200. While a certain number and arrangement of database servers 210, application servers 220, external networks 300, internal user devices 240, and external user devices 260 are illustrated, it should be understood that these are merely illustrative, and that an actual infrastructure may comprise different numbers and arrangements of these components, including additional components or fewer components than illustrated.

Each database server 210 may manage a data store of structured and/or unstructured data. One example of structured data is a relational database (e.g., based on the relational model of data proposed by E. F. Codd in 1970). Examples of unstructured data include media files (e.g., audio, video, images, etc.). A database server 210 may operate independently from other database servers 210, or may operate dependently on other database servers 210 (e.g., as a backup or mirror of the data store or a portion of the data store managed by another database server 210, managing a data store that is cross-indexed with another the data store managed by another database server 210, etc.). Examples of data stores include, without limitation, an inventory database, a customer database (e.g., containing personally identifiable information (PII)), a customer relationship management (CRM) database, a decision support (DS) database, and/or the like.

Structured data stores may be divided into two broad categories: relational (e.g., typically, Structured Query Language (SQL)); and non-relational (e.g., NoSQL). Examples of relational structured data stores include, without limitation, Oracle™, Microsoft SQL Server™ Sybase™, SAP HANA™, PostgreSQL™ MySQL™, MariaDB™ and DB/2™. Examples of non-relational structured data stores include, without limitation, MongoDB™, HBase™ Cassandra™, Couchbase™, Neo4J™, and Virtuoso™. Unstructured data stores, such as file servers, may also contain pools of structured data that are accessible via network 200. Examples of hybrid unstructured/structured data stores include, without limitation, Samba™ serving a Berkeley DB (BDB) key/value store (developed by Sleepycat Software, now Oracle), and Git™. With structure, comes the ability to identify structured data stores at a fine-grained level (e.g., within a network host), and to build detailed models of the data by observing network traffic. Unstructured data stores and transitory network traffic, which may not be related to any data stores, can also be identified and modeled, potentially to a different level of detail than structured data stores.

Typically, each application server 220 communicates with one or a plurality of database servers 210 via one or a plurality of protocols. However, it should be understood that an application server 220 does not necessarily have to communicate with any database server 210, and therefore, an application server 220 could exist that is not communicatively connected to any database server 210. An application server 220 may service internal user devices 240 within network 200 and/or may service external users 340 via an external network 250 (e.g., comprising the Internet), using one or more database servers 210. For example, application server 220A services external users 260 using a database server 210A, with which application server 220A communicates using a protocol A. As another example, application server 220B services external users 260 using a plurality of database servers, including database server 210A, with which application server 220B communicates using protocol A, and database server 210B, with which application server 220B communicates using protocol B. In other words, the same application server 220 may utilize different protocols with different database servers 210, or even different protocols with the same database server 210. As yet another example, application server 220C services internal user devices 240 using a database server 210C, with which application server 220C communicates using protocol C. An application server 220 may also communicate with another application server 220. For instance, application server 220B communicates with application server 220C using protocol D. Examples of application servers 220 include, without limitation, an enterprise resource planning (ERP) and/or manufacturing application server, an operations and/or shipping application server, a CRM application server, a CRM integration application server, a DS application server, a sales support application server, and/or the like.

In general, an application server 220 may service only internal user devices 240 via a single protocol, only internal user devices 240 via a plurality of different protocols, only external users 260 via a single protocol, only external users 260 via a plurality of different protocols, both internal user devices 240 and external users 260 via a single protocol, or both internal user devices 240 and external users 260 via a plurality of different protocols (e.g., a single protocol for internal user devices 240 and a single protocol for external users 260, a single protocol for internal user devices 240 and a plurality of different protocols for external users 260, a plurality of different protocols for internal user devices 240 and a single protocol for external users 260, or a plurality of different protocols for internal user devices 240 and a plurality of different protocols for external users 260). In addition, an application server 220 may communicate with no database server 210, one database server 210 via a single protocol, one database server 210 via a plurality of different protocols, a plurality of database servers 210 via a single protocol, or a plurality of database servers 210 via a plurality of protocols.

Examples of protocols used by application server(s) 220 to communicate with database server(s) 210 (e.g., protocols A, B, and C) include, without limitation, SQL Server™ Oracle™, and/or the like. An example of a protocol used by application server(s) 220 to communicate with other application server(s) 220 (e.g., protocol D) may include, without limitation, HyperText Transfer Protocol (HTTP) or HTTP Secure (HTTPS) with Representational State Transfer (REST). An example of a protocol used by application server(s) 220 to communicate with internal user devices 240 and external users 260 may include, without limitation, HTTP, HTTPS, and/or the like.

Specific examples of various arrangements of database servers 210, application servers 220, and protocols include, without limitation: an ERP and/or manufacturing application server that communicates with an inventory database server via SQL Server; an operations and/or shipping application server that communicates with an inventory database and a CRM database server via SQL Server; a CRM application server that communicates with a CRM database server via SQL Server and with external Internet users via HTTPS; a CRM integration application server that communicates with an inventory database server and CRM database server via SQL Server and with a DS support application server via HTTP/REST; a DS application server that communicates with a DS database server via SQL Server and a customer database (e.g., containing PII) via Oracle, with a CRM integration application server via HTTPS/REST, and with internal management users via HTTPS; and a sales support application server that communicates with an inventory database server via SQL Server and a customer database (e.g., containing PII) via Oracle, and with internal sales users via HTTP.

It should be understood that network 200 may comprise servers 230, other than database servers 210 and application servers 220. Such servers may communicate with other servers, including database servers 210 and application servers 220, as well as internal user devices 240 and external user devices 260 (e.g., via external network 250), and may store and/or communicate structured data (e.g., SQL and/or NoSQL) and/or unstructured data. In addition, internal user devices 240 may communicate with other internal user devices 240 within network 200. For example, user device 240A may communicate with user device 240B. Furthermore, internal user devices 240 may communicate with external user devices 260 via external network 250. For example, internal user device 240A may communicate with external user device 260. It should be understood that network 200 and/or external network 250 may comprise numerous other devices (e.g., servers, end user devices, etc.), combinations of devices, and communication paths than those illustrated.

2. Process Overview

Embodiments of processes for structured data discovery and cryptographic analysis will now be described in detail. It should be understood that the described processes may be embodied in one or more software modules that are executed by one or more hardware processors (e.g., processor 110), for example, as a computer program or software package. The described processes may be implemented as instructions represented in source code, object code, and/or machine code. These instructions may be executed directly by hardware processor(s) 110, or alternatively, may be executed by a virtual machine operating between the object code and hardware processors 110.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

2.1. Introduction

Database servers 210 hold pools of valuable data that are accessed by applications and end users. Government regulations, privacy policies, and corporate governance require sensitive or valuable data to be located and characterized across networks that, in many cases, have been built in an ad-hoc manner. By their natures, database servers 210 place structure on the storage of data. This structure can be modeled based on observed patterns and payload of network traffic, and analytic techniques can be applied to the resulting data models to expose sensitive data and its movement within a network. Experience demonstrates that, in any large network, there are many pools of structured data, and their usage and even their existence are often surprising to the organizations that house them.

Structured and unstructured data operations are frequently transported within a network using cryptographic mechanisms that, directly or indirectly, expose identity, security, and policy features. These features can be used to build a policy and/or security model of the flow of data within the network. Analytic techniques can then be applied to the data model to classify and characterize the traffic flows to prevent data loss, maintain data privacy, and/or satisfy other policy and regulatory requirements.

Machine-learning and expert-system techniques do not generally work well on basic NetFlow data (i.e., Internet Protocol (IP) network traffic entering and exiting a network interface), since such data does not include the structure of the payload data, and the structure of the payload data contains the bulk of the signal, relative to noise. However, if data models are enriched using detailed application-layer information about the structured data and cryptographic metadata, machine-learning and expert-system techniques produce a much better signal-to-noise ratio in data classification, data-loss prevention, intrusion detection (e.g., especially via insider or insider-appearing threats), and the like. Information may be extracted from multiple layers, including, without limitation, L2 (e.g., Ethernet, Address Resolution Protocol (ARP), etc.), L3 (e.g., IPv4, IPv6, etc.), L4 (e.g., Transmission Control Protocol (TCP), User Datagram Protocol (UDP), Internet Control Message Protocol (ICMP), Generic Routing Encapsulation (GRE), Sequenced Packet Exchange (SPX), etc.), and L7 (e.g., Dynamic Host Configuration Protocol (DHCP), Bootstrap Protocol (BOOTP), applications, multiple layers, etc.). It should be understood that references herein to numerical layers (e.g., L7) refer to the layers of the Open Systems Interconnect (OSI) model.

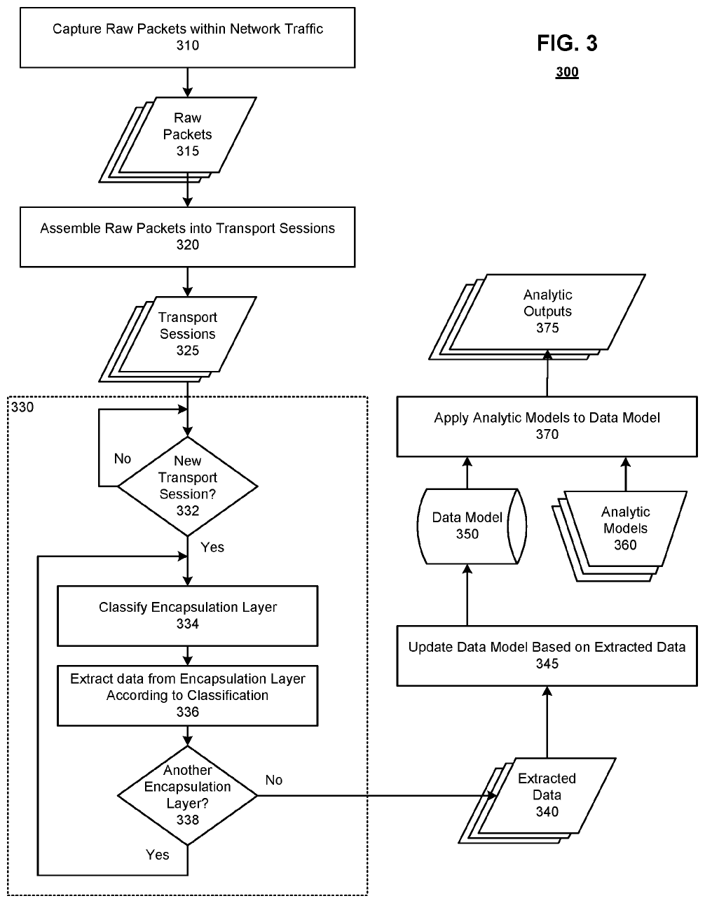

FIG. 3 illustrates an example data flow in a process 300 for structured data discovery and cryptographic analysis, according to an embodiment. Each subprocess in process 300 may be performed continuously in real time, as new data is received (e.g., as network traffic is captured, transport sessions are assembled, data is extracted, etc.), or may be performed periodically using previously collected or queued inputs. Thus, it should be understood that various subprocesses of process 300 may be performed serially and/or in parallel (even if shown being performed serially). It should also be understood that process 300 may be performed by one or more systems 100. For example, process 300 may be implemented as computer-executable instructions that are stored as one or more software modules in main memory 115 and/or secondary memory 120 and executed by one or more processors 110. Different subprocesses of process 300 may be executed by different systems 100. For example, a capture system may perform subprocess 310, an assembly system may perform subprocess 320, a classification system may perform subprocess 330, and an analysis system may perform subprocess 370. Subprocess 345 may be performed by the classification system, analysis system, or a separate system that manages data model 350.

In subprocess 310, traffic within network 200 is captured as raw packets 315. For example, raw packets 315 may comprise IP packets transmitted using Transmission Control Protocol (TCP), User Datagram Protocol (UDP), or the like. The '291 and '125 patents describe exemplary mechanisms that may be used to capture raw packet-level traffic within network 200. In the examples, described herein, it will be generally assumed that TCP is used.

In subprocess 320, raw packets 315 are assembled into transport sessions 325. The transmission and/or capture of packets within network 200 may be asynchronous, such that the order in which raw packets 315 are captured is not necessarily the same as the order of the byte stream required by the L7 application layer. Protocols, such as TCP and Sequenced Packet Exchange (SPX), are designed to work when packets are lost or corrupted between two network agents or endpoints (e.g., a client and server, a server and server, a client and client, etc.). In addition, transport sessions may be established between a plurality of pairs of endpoints and operate asynchronously with respect to each other, such that different transport sessions may overlap temporally. Thus, subprocess 320 differentiates transport sessions, assigns raw packets 315 to one of the transport sessions, and organizes raw packets 315 into their proper sequences to produce assembled transport sessions 325, each representing a synchronous message stream. The '291, '125, and '642 patents describe example mechanisms that may be used to assemble asynchronous raw packets 315 into transport sessions 325.

In subprocess 330, each of transport sessions 325 are analyzed to extract data 340 from each transport session. In particular, each transport session may encapsulate a payload (e.g., a data stream used by the L7 application layer). Subprocess 330 may extract the payload from each transport session, and extract data from one or each of a plurality of layers in which the payload is encapsulated. An iteration of subprocess 330 may be performed for each transport session 325 output by subprocess 320. These iterations may be performed serially, in parallel, or recursively.

Subprocess 330 may comprise subprocesses 332-338. In subprocess 332, if a transport session 325 (e.g., a new transport session that has been assembled in subprocess 320) remains to be analyzed (i.e., “Yes” in subprocess 332), the current encapsulation layer of the transport session 325 being analyzed is classified in subprocess 334. Then, in subprocess 336, available data is extracted from the current encapsulation layer according to the classification. For example, subprocess 334 may classify the encapsulation layer as one of a plurality of possible protocols, and subprocess 336 may extract data from the encapsulated data according to a schema, algorithm, or ruleset associated with the protocol into which the encapsulation layer was classified in subprocess 334. The extracted data may comprise or be derived from content of the encapsulation layer and/or metadata of the encapsulation layer, depending on the protocol.

If another encapsulation layer remains to be analyzed in the current transport session 325 (i.e., “Yes” in subprocess 338), the next encapsulation layer is considered by another iteration of subprocesses 334 and 336. Otherwise, if no encapsulation layer remains to be analyzed in the current transport session 325 (i.e., “No” in subprocess 338), extracted data 340, from all analyzed encapsulation layers, is output. Extracted data 340 may comprise metadata, including cryptographic metadata (e.g., if the payload of the transport session was encrypted), connection metadata (e.g., TCP information, such as whether the connection is unidirectional or bidirectional, whether the start of the connection has been seen, etc.; TLS handshake data, such as certificates, cryptographic parameters, etc.; L7 context; packet counts; etc.), authentication metadata (e.g., login attempts with attempted usernames and/or passwords), operations performed by the payload (e.g., SQL statements or other database operations, Remote Procedure Calls (RPCs), etc.), and/or the like. The data extracted for operations may depend on the operation type (e.g., a row count for SQL statements). If no transport session 325 remains to be analyzed (i.e., “No” in subprocess 332), subprocess 330 continues to wait for new transport sessions 325 to analyze.

In subprocess 345, extracted data 340, extracted from one or more encapsulation layers of one or more transport sessions 325, are used to update a data model 350 of network 200. While data model 350 could comprise all extracted data 340 at the granularity of each transport session 325, such a data model 350 would not be practical and scalable for large networks 350, which may support billions or trillions of transport sessions 325. Accordingly, subprocess 345 may fold extracted data 340 into data model 350 along one or a plurality of dimensions. In other words, within data model 350, extracted data 340 is clustered into groups based on matching values in all dimensions.

In subprocess 370, one or a plurality of analytic models 360 are applied to data model 350 or a portion of data model 350 (e.g., data received in a most recent time window) to produce analytic outputs 375. Each analytic model 360 may analyze one or more characteristics of the data in data model 350 to identify a particular behavior, pattern, or metric in the data. It should be understood that analytic models 360 may each be configured to analyze a different set of characteristics (e.g., data fields), identify a different behavior, pattern, or metric, and/or produce a different analytic output 375 than other ones of analytic models 360. An analytic model 360 that identifies a particular behavior in data model 350 may also be referred to herein as a “behavioral” model. An analytic model 360 may comprise an algorithm, including potentially a machine-learning or other artificial intelligence (AI) algorithm, a ruleset, and/or any other set of instructions that analyzes some aspect of data model 350. Analytic outputs 375 may comprise reports (e.g., for presentation to a network administrator in a graphical user interface), actions (e.g., remedial actions, further analysis, triggering other systems, etc.), and/or the like.

In an embodiment, one or a plurality of capture, assembly, classification, and/or analysis systems may be distributed throughout network 200. Capture system(s) may perform subprocess 310, assembly system(s) may perform subprocess 320, classification system(s) may perform subprocess 330, and analysis system(s) may perform subprocess 370. Each system may comprise system 100 or a portion of system 100, including one or more processors 110 and main memory 115 and/or secondary memory 120 with database facilities, such that varying amounts of processing may be offloaded to each system. Each system may also store and execute software instructions representing an engine designed to perform the corresponding subprocess. For example, processor(s) 110 of the classification system(s) may execute a classification engine implementing subprocess 330, and processor(s) 110 of the analysis system(s) may execute an analytics engine implementing subprocess 370.

In an embodiment in which the capture system and assembly systems are separate and distributed throughout network 200, the capture systems (e.g., taps or other monitoring systems performing subprocess 310) may forward captured packets to the optimal assembly system to be assembled into transport sessions 325. Similarly, in an embodiment in which the assembly systems and classification system(s) are separate and distributed throughout network 200, the assembly systems may forward assembled transport sessions 325 to the optimal classification system to be classified to produce extracted data 340. Similarly, in an embodiment in which the classification system(s) and analysis system(s) are separate, the classification system(s) may forward extracted data 340 to the optimal analysis system for incorporation into data model 350. In all cases, the term “optimal” may refer to the system that has the lowest forwarding cost (e.g., nearest) and/or the greatest available resources. Alternatively or additionally, a capture system and assembly system may be integrated into a single system, an assembly system and classification system may be integrated into a single system, a classification system and analysis system may be integrated into a single system, a capture system, assembly system, and classification system may be integrated into a single system, an assembly system, classification system, and analysis system may be integrated into a single system, a capture system, assembly system, classification system, and analysis system may be integrated into a single system, and/or any other combination of these systems may be integrated into a single system.

In an embodiment, network 200 may comprise a central analysis system that implements a big data cluster analytics engine. If subordinate analysis systems exist in network 200, the subordinate analysis systems may forward their analytic results to the central analysis system to be merged into overall results. The central analysis system may perform subprocess 370 for high-level functions, such as reporting, risk management, cybersecurity, policy compliance, regulatory compliance, and/or the like.

All or subsets of the subprocesses in process 300 may be performed in real time, as raw packets 315 are captured in subprocess 310. Alternatively or additionally, subsets of the subprocesses in process 300 may be performed in non-real time (e.g., periodically). It should be understood that, as used herein, the terms “real time” and “real-time” include instances in which an action is performed in near-real time due to ordinary delays caused by processing and/or networking latencies.

2.2. Packet Capture

In subprocess 310, raw packet-level traffic within network 200 may be captured from one or a plurality of sources, in real time or non-real time. The sources of raw packet-level traffic may include, without limitation, passive network taps (e.g., a Switch Port Analyzer (SPAN) port, passive tapping infrastructure, etc.), client-based and/or server-based network tap agents, terminating and/or man-in-the-middle (MI™) proxies, software defined networking (SDN) flow redirection and/or mirroring, previously captured traffic from a storage device or server (e.g., Packet Capture (PCAP), PCAP Next Generation (PCAPNG), etc.), and/or the like. It should be understood that in an embodiment in which capture systems are distributed throughout network 200, two or more different capture systems may capture the same packet. Thus, raw packets 315 may comprise duplicate packets.

Examples used herein will utilize or assume TCPv4 as the transport protocol. However, it should be understood that embodiments may be applied to transport sessions utilizing other transport protocols, including UDP, multiplexing protocols (e.g., QUIC or similar datagram-based protocols), IPv6, and/or the like. In addition, the encapsulation layers that are analyzed (e.g., in subprocess 330) can include, in addition to L7 layers, multiple L2 (data link) layers, including Fiber Distributed Data Interface (FDDI), Token Ring, and Point-to-Point Protocol (PPP), as well as L3 encapsulation layers (e.g., IEEE 802.1Q), variants of Generic Routing Encapsulation (GRE), and Virtual Extensible Local Area Network (VXLAN).

2.3. Transport

In subprocess 320, raw packets 315 captured in subprocess 310, are organized or assembled into distinct transport sessions 325 (e.g., TCP connections). Each transport session comprises a payload representing a message stream (e.g., requests and responses) encapsulated in one or more layers. In each message stream, missing data (e.g., due to missing packets) may be marked and duplicate data (e.g., due to duplicate packets) may be folded.

Transport sessions that appear to consist of only half a connection (e.g., all captured packets are unidirectionally transmitted by the network agent on only one side of the connection) tend to be a common occurrence in practical packet-capture configurations (e.g., comprising one or more distributed capture systems). These transport sessions, which consist of only half the connection, may be flagged or otherwise identified as consisting of only half the connection to inform higher level (“downstream”) analysis. The identification of groups of connections that suffer from unidirectionality can inform fixes to the packet-capture configuration, while simultaneously providing the downstream analysis (e.g., L7 protocol analysis in subprocess 330) with hints on how to adapt to missing traffic and extract as much valuable data as is available from the message stream.

Subprocess 320 may also comprise monitoring an independent health metric, such as a measure of network loss and/or capture loss (e.g., network loss vs. capture loss). Capture loss refers to packets that are missed by a capture system or dropped en route from a capture system to an analysis system. Such packets are successfully transmitted between two network agents at the ends of a connection, but are not forwarded to an analysis system. Typical reasons for capture loss include a mismatch in the bandwidth available for capturing packets and the bandwidth used for traffic in network 200, a lack of resources in the packet-capture infrastructure, and a misconfiguration of the packet-capture infrastructure (e.g., comprising one or more capture systems). Network loss refers to packets that are lost between the network agents at the ends of a connection. Typical reasons for network loss include overload in network 200 or misconfiguration of the network infrastructure (e.g., at L2 or L3). Connections (e.g., TCP connections) being analyzed may experience both types of loss. The measure of capture and network losses may be monitored for each endpoint in network 200 (e.g., clients and servers) that is included in a discovered transport session, and may be represented in the data model of network 200. These measures may be analyzed (e.g., by the analysis system) to determine where there are problems in the network infrastructure and/or packet-capture infrastructure. In particular, an endpoint that is experiencing high network losses represents a potential problem in the network infrastructure, and an endpoint that is experiencing high capture losses represents a potential problem in the packet-capture infrastructure. The '291, '125, and '642 patents describe mechanisms that may be used to reassemble transport sessions from a noisy packet environment.

Some transport sessions 325 may be encapsulated by an encryption layer, such as IP Security (IPsec), OpenVPN, WireGuard, and the like. When the decryption keys are available, these encrypted transport sessions may be decrypted before assembly in subprocess 320. When the decryption keys are not available, such that the payload of the transport session cannot be analyzed in subprocess 330, the bulk session data may be extracted (e.g., by the metrics process described elsewhere herein), using L2 or L3 to determine high-level session information, and stored in data model 350.

Subprocess 320 may also collect metadata about the transport sessions that are being assembled. This metadata may be useful to higher-level analysis systems. For example, such metadata may be used to report on the prevalence of connection ghosting, which can be useful in configuring a robust packet-capture infrastructure. The collected metadata may be stored in data model 350.

2.4. Discovery of Structured Data

In subprocess 370, an analytic model 360 may be applied to data model 350 to discover structured data within network 200. In particular, the structured data may be discovered by observing accesses of structured data stores within the transport sessions. The nature of the structured data accesses will vary by the technology or vendor of the structured data stores being accessed and the protocols being used to access the structured data stores.

The message streams representing access of structured data may be encapsulated in one or more transport layers and/or application-specific framing layers, including encryption layers. Examples of encapsulation with an encryption layer include, without limitation, Transport Layer Security (TLS), TLS encapsulated inside the Tabular Data Stream (TDS) protocol, TLS encapsulated inside the Transparent Network Substrate (TNS) protocol, Mongo™ or MySQL™ encapsulated inside TLS, Oracle™ or HANA™ native encryption, and the like. An example of multiplexing encapsulation includes, without limitation, SQL Server™ Multiple Active Results Sets (MARS).

The encapsulation layers may be nested in various ways, depending on the application. Thus, subprocess 330 may discover and unpack the nesting being used, before extracting data (e.g., raw structured data operations) from payloads of transport sessions 325 in subprocess 336. In this case, subprocess 336 may be performed after all encapsulation layers have been classified into their respective protocols.

Each data-store technology may support multiple variants, for example, based on the hardware architecture and software versions of the client accessing the data store and server servicing the data store and/or the localization/language configuration of the data store. Subprocess 330 may adapt to these variations by observing the available data and the data interchange. Information gained from one connection in a transport session may be used to inform the data decoding and/or unpacking from other connections in the same transport session (e.g., same client-server pair) and/or in similar transport sessions, when safe to do so based on tested assumptions.

Subprocess 320 may comprise one or more algorithms that resolve missing packets (e.g., due to network loss and/or capture loss) and/or arbitrary starting points based on the data-store technology being accessed. In other words, subprocess 320 may address missing packets in a transport session representing access of one data-store technology differently than missing packets in a transport session representing access of a different data-store technology. Similarly, subprocess 320 may address an arbitrary starting point in a transport session representing access of one data-store technology differently than an arbitrary starting point in a transport session representing access of a different data-store technology. An arbitrary starting point refers to a scenario in which the first packet 315 captured for a transport session is in the middle of the transport session (i.e., a starting portion of the transport session has been missed, for example, due to capture loss).

Advantageously, subprocess 330 is capable of extracting data from each transport session at a plurality of encapsulation layers to derive more information about the transport session than conventional analysis. In addition, the encapsulation layers for each data-store technology may be classified into a protocol (e.g., in subprocess 334) using only the content of the transport session. The port number (e.g., TCP port number) used in the transport session may be used to annotate the relationship between endpoints of a communication session. This port number (e.g., represented as additional bits of metadata) may be used to heuristically determine which endpoint is the client (originator) and which endpoint is the server (acceptor) in the communication session, when the view of traffic is incomplete (e.g., due to packet loss).

In an embodiment, to classify a given encapsulation layer into one of a plurality of supported protocols, subprocess 334 extracts a sequence of one or a plurality of operations from the encapsulated content that is specific to a protocol (e.g., representing a particular data-store technology), subject to variations in the hardware architecture, software versions, and/or language encoding. The extracted sequence of operation(s) may then be correlated to reference sequences in a library of known sequences of operations that are used by the supported protocols. Each reference sequence may be associated with a particular protocol. When the extracted sequence matches a reference sequence, subprocess 334 classifies the encapsulation layer as the protocol associated with that matching reference sequence. Notably, each protocol may be associated with a particular data-store technology, such that the presence of a data store that utilizes a particular data-store technology can be inferred from an encapsulation layer in transport sessions 325 being classified in subprocess 334 as the protocol associated with that particular data-store technology.

The extracted and reference sequences of operations used to classify encapsulation layers into protocols may account for variations in semantics of different versions of each protocol. In addition, the sequences of operations that are extracted from encapsulated content and used as references in the library may comprise or consist of those sequences that have a high probability of matching in various scenarios. These scenarios may include, without limitation, new bidirectional connections, new unidirectional connections, existing bidirectional connections (e.g., capture started in the middle of a session), existing unidirectional connections (e.g., capture started in the middle of a session), and/or connections subject to high packet loss and/or high sampling.

2.5. Discovery of Unstructured Data

The adaptive discovery of data at multiple encapsulation layers, as described herein for structured data, is applicable to unstructured and hybrid data as well. Thus, data model 350 may also model unstructured data, such as all network-level connection data (e.g., TCP connection data). This model of unstructured data may have less L7 data than the structured data, but the extracted metadata may be richer. In any case, the model of unstructured data is useful for analyzing traffic flow and reporting on cryptographic metadata.

When modeling the unstructured data, the client-server direction may be determined based on the first message seen (e.g., which is assumed to come from the client) or, if TLS is used, by the TLS message flow. Subprocess 334 may attempt to classify each transport session by its encapsulation alone. However, if subprocess 334 is not able to classify the transport session by its encapsulation alone, the transport session may be classified by a heuristic based on port number. For example, subprocess 334 may perform a lookup of the port number, used in the transport session, in a lookup table that associates common port numbers with a protocol or service type (e.g., port number 80 is associated with HTTP), to obtain the protocol into which to classify the transport session. As with modeling of structured data, the encapsulation may be detected by content analysis (e.g., TLS connections). Detailed connection metadata may be collected for the encapsulation layers (e.g., TLS), but may be optional for L7 application data.

As with modeling of structured data, subprocess 336 may analyze the decapsulated metadata from high-value unstructured connections, and extract characterizing data as extracted data 340. As discussed elsewhere herein, the data may be folded to prevent this characterizing data from overwhelming storage. Examples of the characterizing data that may be extracted to provide content awareness include, without limitation: Simple Mail Transfer Protocol (SMTP) email header data (e.g., with folding performed at the domain level to facilitate detection of email crossing domain boundaries); identification of Secure Shell protocol (SSH) regardless of port; usage of HTTP proxies to tunnel data, with the ability to detect the usage of cross-domain Web Sockets; directory paths or filenames for Server Message Block (SMB) or Network File System (NFS) file services by a client and server; and/or TCP metadata to detect or log refused connections and correlate clients across multiple connections to detect attempts to map or crawl network 200.

2.6. Data Model

Data model 350 may be built from extracted data 340, output by subprocess 330, which account for the operation streams specific to particular protocols. Data model 350 may organize the data in a technology-neutral format and aggregate characteristics of extracted data 340 in discrete time buckets across one or a plurality of dimensions. As an example, each time bucket may represent a discrete time window or span of five minutes. Entropy-distributing compression may be used on the data in data model 350 to ensure that the storage of past data over the long term is practical without a loss in functionality. Data may be easily extracted from data model 350 across one or a plurality of dimensions or other characteristics and across one or a plurality of time buckets, while being capable of being efficiently stored.

Data model 350 may group extracted data 340 from transport sessions 325 according to a plurality of dimensions that can be used for subsequent fine-grain analysis. These dimensions may include, without limitation, one or more of the following:
Client-server groups of the transport sessions, representing connections between pairs of endpoints identified, for example, by their network-level 1/2/3/4 addresses (e.g., physical port+virtual local area network (VLAN)+security/Security Group Tag (SGT)+IP address+TCP port) and/or an identity derived from the Domain Name System (DNS) or a Configuration Management Database (CMDB);
Authentication used in the transport sessions, such as completed logins with user information, failed logins with usernames and counts of attempted logins, and no authentication;
Identifiers of the applications using the transport sessions, which may be gleaned from login sequences or SQL/remote procedure call (RPC) operations following logins;
Versions of clients and servers;
Cryptographic metadata;
Identifiers of databases within a host (e.g., database server 210);
Other protocol-specific characteristics related to the context of operations; and/or
Fixed time bucket (e.g., of five minutes).

In other words, data model 350 may comprise values for one or more fields that are aggregated for each unique set of values across a plurality of dimensions. These fields may comprise bulk traffic (e.g., in bytes and/or packets) between each endpoint pair (i.e., client-server group), individual SQL and/or RPC operations, operation results and error codes, and/or tables, columns, views, and stored procedures. The SQL and/or RPC operations may be measured in terms of bulk traffic (e.g., in bytes and/or rows) to or from an endpoint (e.g., server) per operation. In addition, in an embodiment, SQL operations may be parsed and semantically analyzed to extract their respective purposes, which may also be represented in the fields. Downstream analysis of statement types may be used to form a tracking context.

Data model 350 may be constructed according to an object-centric schema that catalogs objects in network 200 and the relationships of the objects to each other. The cataloged objects may include, without limitation, databases 210 (e.g., a collection of objects that may be accessed via multiple paths), users (e.g., by username), services, listeners, clients, servers, hosts, realms, SQL statements, RPCs, session metadata, and/or the like. In general, all of the objects are stored “forever.” However, there may be situations in which some of the objects are folded or otherwise trimmed manually or by special purpose tools used in upgrades.

Each object may be represented by a data structure. The data structure for each object may comprise a timestamp indicating the time that the data structure for the object was created. Notably, this timestamp represents the time that the object was first seen, not necessarily the time that the object was created. However, most objects have a unique identifier that globally and monotonically increases. In this case, it may be acceptable to compare these unique identifiers to determine which of two objects was created first.

The data structure for many or all of these objects may comprise a parameter, referred to herein as “unsure,” that indicates when the classification engine has inferred some data or filled in a parameter with dummy data for which the real data was not available. This “unsure” parameter describes the data in the object and does not imply a lack of confidence in the object itself. The “unsure” parameter may be implemented as a Boolean data type. For example, if an object for a service has been marked as “unsure” (i.e., the “unsure” parameter is set to “true” or “1”), this indicates that subprocess 330 has detected the use of a database via the service, but was not able to obtain the name of the service, and therefore, made up a name. However, the “unsure” parameter could also be implemented as a different data type, such as a scalar (e.g., on a scale of 0 to 1, with 0 indicating no confidence and 1 indicating total confidence), a trinary or N-way enumeration (e.g., with 5 values, indicating “sure,” “heuristically determined,” “just a guess,” “synthetic filler data,” or “determined by user policy”), or the like. In general, a null value may be used for data that has not been obtained (e.g., in addition to the “unsure” parameter), but for convenience in reporting, the values of many fields may be filled in with guessed or synthesized dummy data.

After an encapsulation layer has been classified into a specific protocol in subprocess 334, the classification engine may call a specific protocol handler (e.g., a plugin, as described elsewhere herein) to extract data 340 in subprocess 336. At least some of the extracted data 340 (e.g., encapsulated in an L7 protocol) may represent events, such as an SQL execution, RPC execution, client-server activity, login or authentication, and/or the like. As protocol handlers detect events in the data of classified encapsulation layers, they may send the events to an internal feed. The internal feed may bundle the events into internal packages that are associated with the objects involved in the events in order to provide context for the events.

Each package, representing an event in context, may be sent to two destinations: an event log; and a tally system. Alternatively, the event log may be omitted. The event log stores high frequency data for a most recent window of time, and discards data that moves outside that window of time. The tally system summarizes the events for each context. In an embodiment, each summary, referred to herein as a “tally,” contains the number of times each type of event was seen in various modes per context, and a summary of the data (e.g., number of rows, number of bytes, etc.) related to the type of event. It should be understood that the tally system implements subprocess 345, and that data model 350 comprises the tallies.

The context may be defined as a time identifier, an event type, (e.g., SQL statement, RPC, etc.), and the ipseity of the event, which is a combination of objects associated with the event (e.g., client, server, service, and user for the event). The time identifier may represent a number of fixed-size time buckets that have elapsed since the Unix epoch or other starting point. For example, each time bucket may have a span of five minutes.

In an embodiment, data model 350 retains the tallies forever, but the resolution of the time span for the kept tallies decreases over time as the tallies age. In particular, an archival engine may operate periodically (e.g., nightly) on data model 350 to fold the oldest tallies for a given event type and ipseity into one or more aggregate tallies with the same event type and ipseity, but a time span identifier representing a longer time span (i.e., a plurality of time buckets). However, even in this case, a synthetic view of tallies may be provided as if all tallies were at the full resolution of the fixed-size time slots (e.g., five minutes). Example queries that may be run on the tallies in data model 350 include, without limitation: retrieving all discovered servers (e.g., database servers, application servers, etc.), along with their respective protocols and dialects; retrieving a count of tallies by operation type and/or statement type; and retrieving traffic summaries (e.g., packets and/or bytes) by ipseity.

Alternatively or additionally, tallies may be folded along dimensions other than time. It should be understood that as used herein, the term “folded” means that objects in data model 350 are combined, aggregated, grouped, or clustered along at least one dimension. In an embodiment, the oldest tallies could also be discarded, for example, once they exit a predetermined time window (e.g., four months in the past). Tallies may also be discarded based on another dimension. For example, tallies related to a specific domain, network segment, or protocol could be discarded.

2.7. Example Usages of Data Model

Data model 350 may be used for one or a plurality of downstream functions, including reporting, alerting, and/or other applications. For example, in the illustrated embodiment, one or more analytic models 360 may be applied to data model 350 to produce analytic outputs 375 (e.g., reporting and/or actions). Data model 350 may be updated in real time (e.g., by subprocess 345) and feed the downstream function(s) in real time.

As an example, data model 350 may be analyzed to report the identities and locations of data stores observed in the traffic captured within network 200 (e.g., captured in subprocess 310, assembled in subprocess 320, and classified in subprocess 330), measures of traffic to and from the identified data stores, cryptographic metadata related to the identified data stores and/or data flows to and/or from the data stores, the encapsulation layering used by the data flows, and/or the like. Reporting may distill the detailed information into a form that enables a user (e.g., administrator of network 200) to understand where the pools of structured and unstructured data reside within network 200 currently and/or over time, where this data is flowing within and/or outside of network 200 currently and/or over time, how this data is being used currently and over time, and/or the like.

In an embodiment, data model 350 may be analyzed to construct a data web that represents data flows within network 200. Sensitive data may be stored in known structured data stores, but find its way elsewhere within network 200. An analysis of the flow of structured data and the transition to unstructured data flows can indicate where data is residing or to where data is being copied. The data web analysis may use the details of the structured and unstructured data flows, correlated by time and/or content, to show where specific classes of data may be flowing within network 200. For example, an unusual flow of PII data can be detected by correlating times, metadata, traffic volumes, traffic direction, and/or traffic content. The data web may be represented as a graphical illustration of network 200 (e.g., using vertices and edges), with visual depictions of data stores and other endpoints (e.g., as vertices) and data flows (e.g., as edges).

As another example, data model 350 may feed an insider threat detection system that alerts one or more users (e.g., an administrator of network 200) to potential insider threats. The insider threat detection system may utilize the cryptographic metadata, bulk traffic measures, return codes, row and/or byte counts per operation, time buckets, failed logins, SQL operation data, and/or other dimensions in data model 350 according to a threat detection framework. The insider threat detection system may be implemented as an analytic model 360 that monitors unexpected or changing relationships between these dimensions and over time, and may alert user(s) when these relationships indicate an insider threat. The alert may comprise any form of notification, including a text message (e.g., Short Message Service (SMS) or Multimedia Messaging Service (MMS) message), email message, in-app message, automated telephone call with voice message, and/or the like. In addition, a graphical user interface may be provided (e.g., by an administrative server within network 200) that enables a user to drill down into a report, derived from data model 250, according to each dimension or combination of dimensions.

As other examples, data model 350 may be used to locate structured data assets across a wide range of vendors and technologies, identify users of the structured data and determine if the identified users fit into an organizational policy related to the structured data (e.g., whether or not the data being accessed crosses between organizational or other domain boundaries, whether or not the data is being accessed from an external network 250, such as the Internet, etc.), quantify the use of encryption to access structured data (e.g., whether or not structured data assets are protected or hidden by encryption, whether or not the encryption is strong enough or satisfies organizational or regulatory requirements, whether or not structured data assets that should be encrypted are being transported without encryption, etc.), generate metrics for the traffic to and from servers that indicate, for example, unauthorized or attack probe scenarios, data exfiltration via new clients or cracked existing application servers, and/or unusual access by time of day and credentials, and/or the like.

3. Cryptographic Metadata

In an embodiment, extracted data 340 comprises cryptographic metadata that has been extracted for cryptographic encapsulation layers (e.g., TLS). Encrypted communications may be used to provide authenticity, confidentiality, and integrity of messages. The cryptographic metadata may identify the cryptographic protocol and encapsulation for a given transport session 325, as classified in subprocess 334. This cryptographic metadata can be folded into data model 350 for all cryptographic protocols that are encountered, so that data model 350 can be analyzed to summarize the overall usage of each cryptographic protocol, by vendor or technology, within network 200. For example, such analysis may produce a report that details the ratio of structured traffic to unstructured traffic or the percentage of structured traffic and/or unstructured traffic to overall traffic, the percentage of structured traffic that is encrypted, a break-down of encrypted traffic and cleartext (i.e., unencrypted) traffic by vendor or technology, and/or the like. Such information, solely derived from analysis and classification of the encryption layer, can serve many threat-detection and policy scenarios.

However, in an embodiment, the cryptographic metadata may comprise a much richer set of metadata associated with the cryptographic envelope. Depending on the particular vendor and technology being used at the application layer, this richer set of metadata may be extracted from different encapsulation layers in the protocol stack. For example, metadata may be extracted from a TLS layer based on the TLS cryptographic standard, encrypted network and tunneling protocols (e.g., OpenVPS, IPSec, etc.), and proprietary encryption protocols (e.g., Oracle Native encryption). However, only a limited set of metadata can typically be extracted from proprietary encryption protocols, and the metadata gleaned from encrypted network and tunneling protocols is generally less relevant to per-connection traffic analysis. In any case, the end result is a set of data in the cryptographic metadata in extracted data 340 that characterizes the encryption.

Cryptographic metadata derived from a TLS layer may comprise one or more certificates used for the connection and/or cryptographic parameters (e.g., cipher suites) used for the connection. The cryptographic metadata may be used to independently validate trust by analyzing the actual usage of certificates in network 200 and evaluate the cryptography and real-time trust of encrypted connections within network 200.

The cryptographic metadata may be extracted from the TLS handshake of a transport session 325. In an embodiment, TLS handshakes may be cached and indexed by their respective session identifiers, so that they may be retrieved from the cache using a session identifier. The session identifiers may be used to keep a parallel cache of the metadata extracted from TLS handshakes associated with each session identifier. This can be used to associate transport sessions 325 that use a previously seen session identifier with the cached metadata that has been previously extracted and associated with that session identifier. In other words, the metadata is extracted once when the session identifier is first seen, and then retrieved from the cache each time that the session identifier is seen again. The use of the cache in this manner can improve the speed and efficiency of subprocess 330.

Notably, TLS 1.3 provides for encryption of some of the TLS handshake, including the certificate data (e.g., certificate chain) sent by the server. Consequently, without the decryption key, the certificate data cannot be extracted (e.g., in subprocess 336), which can hinder downstream analysis. Thus, in an embodiment, when TLS 1.3 is detected in a transport session 325 (e.g., in subprocess 334), an internal mechanism (e.g., in subprocess 330) may connect to the server in question, perform a key exchange with the server (e.g., a Diffie-Hellman (DH) key exchange), and use parameters identical or similar to the parameters used by the original client on the other side of the transport session 325 to perform at least the portion of the TLS handshake necessary to obtain the certificate data. Once the certificate data has been obtained, the TLS handshake may be aborted. Since a server typically uses the same certificate data for all clients, the certificated data gleaned from this aborted connection probe can be used for all observed traffic between the particular server and clients. In an alternative embodiment, which requires no key or additional connection probe, a man-in-the-middle proxy can be constructed between the client and server.

If encrypted server name indication (ESNI) is used to encrypt the name of the server in question, the server name may be derived from a DNS lookup performed on the observed IP address for the server. In cases in which there is a one-to-many mapping between IP address and server names, a plurality of DNS lookups may be performed and/or observed DNS cleartext queries from the client may be used to determine a list of server names to probe. Alternatively or additionally, if non-TLS-1.3 traffic to the server is observed, the list of server names to probe may be built to include the Server Name Indications (SNIs) in this non-TLS-1.3 traffic. When many-to-one activity is detected, and a transport session 325 cannot be pinned to a single server, the server associated with the transport session 325 may be flagged using the “unsure” parameter, so that downstream analysis may consider all possible certificate data for the server. In the above manner, server endpoints within network 200 may be automatically discovered.

Cryptographic metadata incorporated into data model 350 may be analyzed by one or more analytic models 360 or other analysis techniques to derive insights into data stores and data flows within network 200. The analyses may consider basic cryptographic data (e.g., protocol, dialect, and/or encryption mode) and/or detailed cryptographic data (e.g., certificate chain, cryptographic parameters, etc.). In some cases, the analyses may result in active measures (e.g., analytic outputs 375) being taken, such as blocking a connection and/or proxying a connection.

4. Example Analytic Models

In an embodiment, data model 350 may be analyzed in terms of one or more boundary crossings. A boundary may be a network-level boundary (e.g., different subnets, Border Gateway Protocol (BGP) prefixes, VLANs, TCP port regions, etc. on opposing sides of the connection), an organization boundary (e.g., different DNS name parts, different certificate issuers, etc. on opposing sides of the connection), or a policy boundary (e.g., different Security Group Tags (SGTs), IP Type of Service (ToS) tags, etc. on opposing sides of the connection). When traffic is observed crossing one of these boundaries (i.e., the two ends of a connection lie across the boundary), this crossing may be flagged in a report and/or alert or trigger one or more actions (e.g., in analytic outputs 375). Such boundary-crossing analysis may be combined with other types of analysis to enhance the analysis, reporting, and/or the like.

In an embodiment, an analytic model 360 may be applied to data model 350 in subprocess 370 to identify one or more errors occurring in the network traffic. An error may represent an unexpected situation in which an attack is likely. In more routine cases, an error may result from a misconfiguration or operational issues that are not easily detected by users or administrators of network 200. Global analysis of configuration errors and similar errors can provide an early warning system that applications (e.g., operating on application servers 220) may be failing or may fail in the future.

Networks 200 grow and change organically over time. In an embodiment, subprocess 370 is applied continuously, rather than periodically or occasionally, such that an analytic model 360 may monitor changes to one or more characteristics of the data of data model 350 over time. For instance, an analytic model 360 may comprise a machine-learning model that is trained to detect unexpected changes in one or more characteristics of the data. Examples of such characteristics include, without limitation, traffic volume by time, certificate root, cipher parameters, SNI, canonical name (CNAME), alternative domain name (ALTNAME), Application-Layer Protocol Negotiation (ALPN) data, and/or the like. These characteristics have high value for statistical analysis on a per-session basis (e.g., on a given group of connections).

As an example, if encrypted data crossing a boundary between an organization and the Internet and using a self-signed certification is usually tens of megabytes per day, but the encrypted data jumps to many gigabytes on a particular day, this could indicate a data exfiltration attempt in progress. However, if encrypted data crossing a boundary between an organization and the Internet and using organizationally trusted roots or specific external certificates is usually tens of megabytes per day, but the encrypted data jumps to many gigabytes on a particular day, this may be acceptable. Such a scenario may represent a backup or replication of data to an external cloud network. Identifying the roots of trust for analytic models 360 enables a much higher signal-to-noise ratio than would otherwise be possible for this type of statistical analysis.

Within a given domain, data may be encrypted or unencrypted and may be transported in structured or unstructured data flows (e.g., as determined by protocol and dialect). In an embodiment, an analytic model 360 may be applied to data model 350 in subprocess 370 to report the transport of encrypted and/or unencrypted data and/or the protocols and/or dialects used. The reported information may be organized in terms of clients and/or servers, and optionally grouped by subnet or DNS name parts. Such information can inform an organization as to what percentage of traffic within network 200 is protected by encryption and/or what percentage of traffic within network 200 is not protected by encryption. This information may be organized in reports in terms of specific clients or servers, such that unprotected or under-protected applications and/or data stores can be identified. In addition, the information may be organized in terms of boundary crossings, such that client-server session groups that span sensitive boundaries can be identified.

In an embodiment, an analytic model 360 may be applied to data model 350 in subprocess 370 to detect self-signed certificates and/or certificates signed by an untrusted root. This information may be reported in terms of clients (e.g., application) and/or servers (e.g., data stores), such that the usage of potentially untrusted channels may be identified. Such channels may be subject to man-in-the-middle attacks. When applied to the client end of a connection, policy overrides by the end user (e.g., installing untrusted certificate authorities, accepting untrusted certificates, etc.) can be detected. Such analysis can also identify data exfiltration that is attempting to hide from traditional forms of data loss prevention (DLP). Time and other context (e.g., traffic volume and direction) can be used to identify the highest priority servers or applications to target for investigation and/or remediation. In addition, the information may be organized in terms of boundary crossings, such that cross-domain certificate trust issues can be identified.

In an embodiment, an analytic model 360 may be applied to data model 350 in subprocess 370 to detect long certificate chains being used by groups of servers or applications. A long certificate chain may be any certificate chain with a length greater than a predetermined threshold (e.g., greater than three certificates). A long certificate chain may be indicative of an unexpected signing entity.

In an embodiment, an analytic model 360 may be applied to data model 350 in subprocess 370 to detect the use of unacceptable cryptographic parameters. Examples of cryptographic parameters include, without limitation, cipher algorithm, key size, TLS versions, extensions (e.g., Key Usage), key exchange method, key exchange bits, hash algorithm, alerts, sesson resumption, and the like. Unacceptable cryptographic parameters may be those that violate a security posture or security policy of the organization using network 200, even though such parameters may be acceptable to the end points of connections. Detection of unacceptable cryptographic parameters, organized in terms of traffic volume and end points, enables the identification of obsolete or misconfigured servers and/or clients. This analysis may be used to detect and remediate vulnerable servers and/or clients. For example, victims of the Heartbleed security bug may be discovered in real time.

In an embodiment, an analytic model 360 may be applied to data model 350 in subprocess 370 to detect expired or soon-to-expire certificates. Such certificates cause various forms of security and operational issues. The analysis may report information about servers and/or traffic in terms of how much time remains before expiration of the certificates in their respective certificate chains. This enables the detection of expiring certificates before the situation becomes critical (e.g., before a loss of service occurs). This also enables the detection and reporting of applications that have already lost service due to an expired certificate (e.g., caused by handshake failures).

In an embodiment, an analytic model 360 may be applied to data model 350 in subprocess 370 to detect compromised certificate authorities (CAs). In particular, certificate authorities, which are acceptable to browser vendors or stock operating system (OS) libraries, may be compromised or unacceptable for use within a particular domain of network 200 or across one or more boundaries. Thus, the analysis may report on sessions that attempt to use blacklisted certificate authorities, unknown certificate authorities that are not self-signed, known internal certificate authorities that may have been distributed and installed by developers or other organizations that are no longer usable, and/or the like. This information may be filtered and/or enhanced by boundary crossings to identify the use of particular certificate authorities across particular boundaries.

In an embodiment, an analytic model 360 may be applied to data model 350 in subprocess 370 to detect revoked certificates. As an alternative mechanism to a certificate authority's Certificate Revocation List (CRL), Online Certificate Status Protocol (OCSP) can be used to verify that certificates have not been revoked. OCSP stapling appends a time-stamped OCSP response, signed by the certificate authority, to the response to the initial TLS handshake, thereby reducing load on the infrastructure. A security posture or policy of an organization using network 200 may dictate that only certificates (root and/or intermediate certificates) that have an OCSP extension are usable. Thus, the analysis may report on the presence or absence of OCSP extensions on a per-session basis, including missing or invalid stapled OCSP responses. In addition, the analysis may identify all known OCSP servers, to be used internally to determine if the correct certificate configuration is being used consistently within network 200. Optionally, subprocess 370 may send an OCSP probe to URLs of network agents (e.g., servers) to determine whether or not the network agents are still using certificates that have been revoked. This information can be used to identify potentially compromised servers, and trace where the data that a server served after its certificate had been revoked or just before its certificate was revoked was used. This can enable damage control, if necessary, after a CA breach or other security breach. All of the information reported by the analytic model 360 may be filtered and/or enhanced by boundary crossings.

In an embodiment, an analytic model 360 may be applied to data model 350 in subprocess 370 to report on APLN data. APLN is a TLS extension that identifies what protocol will be encapsulated within TLS, in a manner that is analogous to looking up a port number. Many protocols are registered with APLN, including HTTP, HTTP/2, File Transfer Protocol (FTP), Internet Message Access Protocol (IMAP), Post Office Protocol version 3 (POP3), eXtensible Messaging and Presence Protocol (XMPP), and the like. Thus, the analytic model 360 can read the APLN to identify the purpose of an otherwise opaque connection. The APLN data can be used to segregate unstructured data by application and may be compared to the classified encapsulation layers in the payload of the transport sessions 325. The APLN of a TLS layer can also be read in subprocess 334 to classify the protocol encapsulated by the TLS layer in cases in which decryption of the payload is not possible (e.g., because decryption keys are not available). These classifications can be aggregated by server to show the encrypted services, and thereby the type of stored data, by server or server group, even when the payloads of transport sessions 325 cannot be decrypted.

In an embodiment, an analytic model 360 may be applied to data model 350 in subprocess 370 to report on Server Name Indication (SNI) data. SNIs in transport sessions 325 can be used to determined the requested destination of encrypted traffic that is traveling through a proxy or to a shared server. For example, the analytic model 360 may compare the SNI data to the DNS data obtained by a reverse lookup of the IP address of the target server in transport session 325 to determine whether or not the target server is being used as a “jump box” to exfiltrate data or is misconfigured. In particular, a mismatch of the SNI data and the DNS data may indicate that the target server is being used for exfiltration or is misconfigured. Thus, the analytic model 360 may report on SNIs used by servers that indicate data breaches. The analytic model 360 may also report on SNI usage by clients, which especially in combination with the analysis of boundary crossings, can facilitate monitoring of opaque, encrypted data flows across network 200.

In an embodiment, an analytic model 360 may be applied to data model 350 in subprocess 370 to collate and/or report clients and servers that offer insecure cryptographic parameters, such as insecure cipher suites, suspect National Institute of Standards and Technology (NIST) elliptical curve (EC) parameters, and/or the like, negotiate and use insecure parameters, and/or offer or negotiate perfect forward secrecy ciphers, such as Diffie-Hellman Ephemeral (DHE)-Rivest-Shamer-Adelman (RSA), Diffie-Hellman Algorithm (DHA)-Digital Signature Algorithm (DSA), ECDHA-RSA, and/or ECDHA-ECDSA. This information can be used to strengthen communications, both internal to network 200 and external to network 200, and/or catalog internal communications in network 200 that may be hidden from security systems (e.g., ad-hoc attacker traffic, exfiltration traffic, etc.).

In an embodiment, an analytic model 360 may be applied to data model 350 in subprocess 370 to analyze failed handshakes and other client rejections. For example, the analytic model 360 may gather data from failed TLS handshakes, such as the offered ciphers and other cryptographic parameters for each failed transport session 325, as well as the indication that the handshake failed, including the details in the “alert” message data indicating why the negotiation was rejected. This analysis can identify attacks in progress or active configuration issues, such as a server setup with an incomplete certificate chain, corrupt or expired certificates, certificates with missing extensions, refusals to downgrade (e.g., failed attacks), old or unsupported library versions (e.g., with no common ciphers), and/or the like.

In an embodiment, an analytic model 360 may be applied to data model 350 in subprocess 370 to catalog and classify the hosts in network 200 and/or fill in and/or update an organizational CMDB. This cataloging and classification may be performed automatically or manually based on a report output by the analytic model 360. In the case of a report or for auditing and inherent risk (IR) purposes, the analysis results may be viewed, grouped, sorted, exported, and/or the like, along one or more of the following dimensions: traffic volumes (e.g., by packets and/or bytes); cipher suites offered and/or used; certificates accepted; root certificate authorities accepted, SNIs requested, CNAME and ALTNAME data server along with DNS names, and/or the like. The reporting may be combined with analysis of boundary crossings to inventory data within network 200 by their respective domains, identify leakage between domains, and/or determine overall encryption safety and stance.

In an embodiment, an analytic model 360 may be applied to data model 350 in subprocess 370 to detect firewall bypasses. For example, many organizations allow protocols, such as HTTPS or DNS, to directly connect, possibly via a proxy. These channels can be used by an insider to bypass DLP and intrusion detection system (IDS) mechanisms by encrypting the payload. The analytic model 360 may analyze traffic volume and data flow chains to detect when these types of firewall bypasses occur. In addition, cryptographic metadata (e.g., SNI, ALPN, certificates, etc.) may be used to detect unauthorized traffic across these channels.

In an embodiment, an analytic model 360 may be applied to data model 350 in subprocess 370 to detect man-in-the-middle attacks or misconfigurations. For example, the analytic model 360 may compare CNAME and ALTNAME extensions to the DNS data for servers within network 200 to determine when a server is serving the “wrong” certificate. Such a situation is indicative of a man-in-the-middle attack or a misconfiguration of the server.

In an embodiment, an analytic model 360 may be applied to data model 350 in subprocess 370 to detect attacks and/or vulnerabilities to attacks in network 200. The encryption stack sees its share of faults and it frequently takes a long time to upgrade hosts within a network 200 of an organization. Thus, the analytic model 360 may analyze the cryptographic metadata collected in data model 350 to identify servers and clients that are vulnerable to specific attacks and/or involved in a specific attack, as well as bugs and zero-day vulnerabilities. Types of attacks that may be detected include Heartbleed, Padding Oracle on Downgraded Legacy Encryption (POODLE), other downgrade attacks such as Factoring RSA Export Keys (FREAK) and Logjam, and others.

In an embodiment, analytic models 360 may analyze data model 350 to perform any one or more of the following functions for reporting/alerting (e.g., as analytic outputs 375):
Identify the usage of expired certificates in encrypted communication sessions (e.g., to identify or otherwise report on servers or other locations within network 200 that are utilizing expired certificates).
Identify the usage of unencrypted (cleartext) communications and/or encrypted communications (e.g., to identify or otherwise report on communications paths within network 200 that are unencrypted and/or encrypted, such as the usage of Lightweight Directory Access Protocol (LDAP) vs. Secure LDAP (LDAPS)).
Identify encryption quality and/or risk (e.g., to report on RSA signature length) based on cryptographic metadata (e.g., TLS version, cipher suite, etc.).
Detect man-in-the-middle attacks.
Map and discover applications operating with network 200 (e.g., on an application server 220).
Detect stolen certificates being used on new servers.
Detect ransomware, malware, advanced persistent threats (APTs), and/or the like.
Analyze certificate trust within network 200 (e.g., detect self-signed certificates, untrusted or rogue certificate authorities, etc.).
Analyze the population and trust of certificate authorities used in network 200.
Identify wildcard certificates.
Identify defective certificates, which violate a policy, utilize outdated technology, and/or the like.
Inventory certificates used within network 200 for increased visibility, auditing, enabling certificate management, and/or the like.
Inventory databases (e.g., managed by database servers 210) within network 200.
Measure certificate usage within network 200.
Detect certificate changes within network 200.
Measure on-net/off-net certificate usage within network 200.
Detect missing backups or database replications (e.g., to trigger an alert).
Identify and/or classify sensitive endpoints based on the content of traffic and/or the metadata extracted from traffic to or from the endpoints.
Collect information (e.g., database inventory) for enhancement and/or real-time updates of a CMDB/asset database.
Validate Cybersecurity Maturity Model Certification (CMMC).
Collect information to enhance Nedlow data (e.g., with extensions for databases, encryption, etc.).
Detect incidents (e.g., database login failures) and collect forensic information on the incidents.
Identify financial Internet of Things (IoT) devices, such as a personal identification number (PIN) code machine.
Automatically or semi-automatically (e.g., with some manual intervention) monitor backups (e.g., to detect ransomware).
Perform segmentation-based analysis on any of the data in data model 350. For example, differential and/or static analysis may be performed on any of the data identified, collected, or measured in the above points, but limited to certain groups of endpoints (e.g., segmented by department, such as accounting vs. human resources, or by organization, such as administration vs. student housing). As another example, the data may be segmented by internal assets (e.g., organizational assets, on-premises assets, cloud-based assets, Software-as-a-Service (SaaS) assets, etc.) versus external assets (e.g., third-party Internet assets). As yet another example, leaks between segments (e.g., trading vs. engineering) may be analyzed. Segments may be defined by one or more attributes or dimensions, including, network address, DNS names, VLAN tags or SGTs, physical or logical tap sources, application usage (e.g., based on certificate data), specific server usage, long-term relationships (e.g., a specific client endpoint usually uses a specific set of servers or communicates with a specific set of peers), time of day (e.g., specific shifts or operating hours depending on time zone/country), and/or the like.
Analyze a specific endpoint, for example, to generate a detailed report for a single node in network 200 (e.g., identifying and/or measuring the type of traffic to and from the node), for forensics, and/or the like.
Analyze data model 350 to produce an insurance-specific audit report (e.g., for a customer or insurance company).
Detect the usage of the same certificate on multiple endpoints.
Detect misconfigured firewalls.
Detect and/or measure grey failures, such as failures in the network Access Policy Manager (APM), routers dropping more packets than usual, an increase in retransmissions representing network loss, unusual routes or changing routes in a multi-homed network, and/or the like.
Detect unwanted communications (e.g., of commands and/or data) between endpoints, such as two internal user devices 240, for example, representing an attack.

5. Active Measures

Results or actions 375, resulting from the application of analytic model(s) 360 to data model 350, may comprise active measures. Active measures may be particularly advantageous when process 300 is being performed in real time, as they can be used to prevent or mitigate attacks in progress.

For example, the active measures may comprise a structured data firewall that protects particular databases 210 that an analytic model 360 has determined contain sensitive data, such as PII. In other words, the analytic model 360 may identify the locations of databases 210 to protect based on analysis of data model 350, and a central or distributed response system (e.g., comprising at least a portion of a system 100) in network 200 may actively block, redirect, or transform structured data requests to the locations of those identified databases 210. Hence, access to sensitive data, such as PII, can be managed via network-level rules, rather than or in addition to database configurations. For example, structured network address translation (NAT) may be used to redact or tokenize structured data queries in order to redirect attacks (e.g., SQL injection, as detected in embodiments of the '125 patent) to a honeypot, redact data, or block access altogether. As another example, the response system may block use of the “master” database across a domain boundary (e.g., a boundary between network 200 and a perimeter network or demilitarized zone (DMZ)) by dropping any connection that attempts to query the “master” database from outside the domain of the database 210 storing the “master” database.

Notably, because the disclosed system is in the traffic flow of network 200, it can rewrite or block traffic based on the output of an analytic model 360. For example, it can construct a man-in-the-middle-style proxy or implement an IDS or network-level (e.g., L3/L4) firewall. As an example, assume that an internal user device 240 (e.g., laptop) attempts to log in to a database server 210 in a campus network 200, from a cafeteria of the campus, using administrator credentials. An analytic model 360 may flag this based on an organizational policy that only administrator workstations should be used to log in to database servers using administrator credentials. The analytic model 360 may responsively trigger (e.g., as analytic output 375) the system to block the login attempt by not allowing the connection handshake to be completed. This may be implemented by changing the packets between internal user device 240 and database server 210. In an embodiment, such an analytic model 360 may comprise a machine-learning model that is trained to block connections that violate even vaguely defined policies, such as “don't allow untrusted endpoints from talking to machines in the data center” or “don't allow connections using encryption that isn't trusted by our company CA.”

The policy for a network 200 of an enterprise or campus may require that certain classes of data be encrypted during transport. The policy may define the specific certificate roots and/or cryptographic parameters that must be used to transport these classes of data, to ensure that the IDS and similar systems have visibility into all the encrypted data for purposes of virus scanning, DLP, and/or the like. A traditional firewall would be deployed at the perimeter of a trust zone to block traffic, based on ports or deep packet inspection (DPI) of the contents of application-specific messages.

In an embodiment, the response system may implement a cryptographic firewall that uses cryptographic analysis (e.g., an analytic model 360 that identifies certificates being used) to provide features that may be used to block, shape (e.g., reduce bandwidth), or redirect (cryptographic NAT) traffic on a connection-by-connection basis. For example, the cryptographic analysis may trigger one or more of the following actions (e.g., as an analytic output 375):
Traffic that uses an undecryptable DH cipher, RSA, or static DH keys that are not in a shared hardware security module (HSM) can be redirected through a transparent proxy that changes the encryption to one that may be monitored.
Traffic that uses untrusted certificate roots may be blocked or flagged in real time.
Traffic that uses self-signed certificates may be blocked or redirected through a transparent proxy for monitoring.
Traffic volumes for hidden traffic may be limited (e.g., to a packet or byte limit) to encourage the use of appropriate certificates without breaking the communications.
Browsers' built-in trusted CA list may be “edited” in real time by disallowing specific certificate authorities that may have been trusted by the browser but that are known to be hostile. For example, a man-in-the-middle proxy or IDS can be used to redirect or disrupt the connection. As discussed elsewhere herein, the system is capable of independently validate certificate trust (e.g., without participation of the involved endpoints) based on organizational policy. Thus, an organizational policy can be set that disallows any certificates by a first certificate authority (e.g., GoDaddy CA) while allowing any certificates by a second certificate authority (e.g., NY Stock Exchange CA), even though browsers may trust the first certificate authority. This is much more efficient than setting the trust of each browser, which is not always possible and which often come with out-of-the-box trust settings which may not agree with organizational policy. This mechanism can be used at the carrier/transit level to immediately block traffic when a certificate authority or subordinate certificate authority has been compromised.
Security can be “upgraded” by negotiating modern or perfect forward secrecy (PFS) cipher suites on the Internet side of traffic, while allowing the transparent use of older, insecure stacks and cipher suites on internal hosts within network 200. Thus, upgrades to internal network hosts can be deferred or obviated.

In response to the discovery of a bug in cryptographic layer implementations (e.g., Heartbleed in TLS), cryptographic NAT can be used to route traffic through a transparent (internal or external) proxy that “patches” the bug, to effectively prevent exploitation of the bug in network 200.

6. Recursive Classification

In an embodiment, classification of the encapsulation layers in subprocess 330, and more particularly in subprocess 334, may be performed recursively to classify each encapsulation layer into a protocol on a protocol stack. Data may be extracted from each encapsulation layer, in subprocess 336, either as the protocol stack is built, or after the protocol stack has been completed (e.g., by popping off the protocol on the top of the protocol stack, and so on and so forth until the protocol stack is empty).

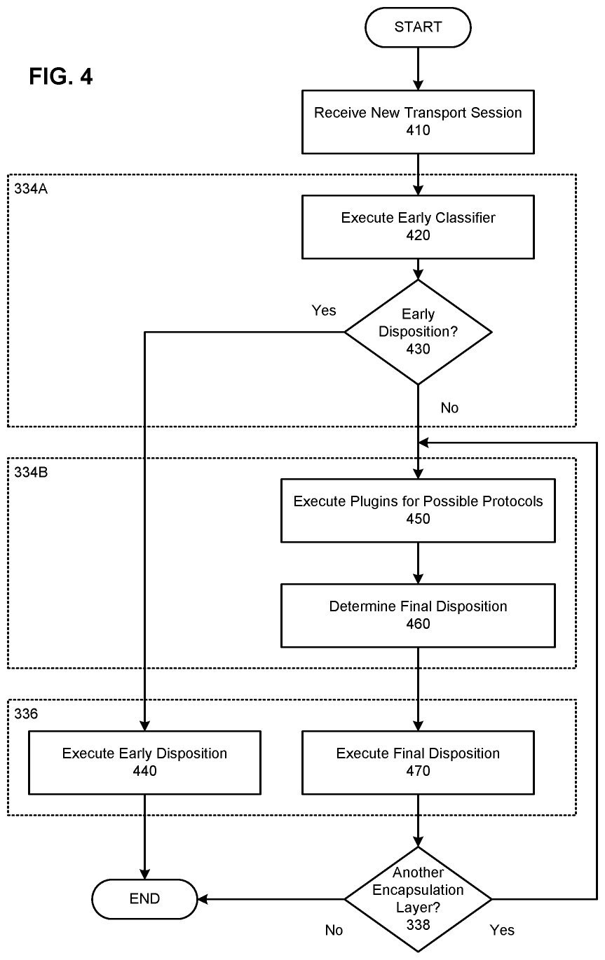

FIG. 4 illustrates recursive classification and disposition of encapsulation layers in subprocess 330, according to an embodiment. In subprocess 410, a new transport session 325 is received. In an embodiment, subprocess 334 is split into an early classification process 334A and a full classification process 334B. Thus, in subprocess 420, an early classifier is executed on the payload of the received transport session 325 (e.g., TCP connection). The early classifier may determine whether early disposition is warranted based on rules defined for tuples of server IP address, server port, client IP address, client port, and realm of the transport session 325. Transport sessions 325 with certain tuples may not warrant full classification. When one of these tuples matches a rule of the early classifier (i.e., “Yes” in subprocess 430), early disposition may be executed in subprocess 440.

Early disposition in subprocess 440 may comprise sending the transport session 325 to a metrics process, a “blackhole” process, or a dump process, depending on the tuple and/or the system configuration. For example, transport sessions 325 with specific tuples (e.g., all traffic from a particular client) may be routed to a designated one of these processes, whereas all other transport sessions 325 proceed to subprocess 450.

The metrics process may measure one or more characteristics of the transport session 325, such as the number of packets and/or bytes transported in each direction of the connection (e.g., client to server, and server to client). Although specific information about the transport session 325 is not acquired, the measured characteristics may still be useful for analysis of traffic within network 200.

The blackhole process may simply discard the transport session 325 without reporting anything. This may be useful when only L7 data is desired to be incorporated into data model 350 and the transport session 325 is encrypted and undecryptable.

The dump process may store the raw data from the transport session 325 into a dump file. The dump file may be formatted as hexadecimal number representations or American Standard Code for Information Interchange (ASCII) text representations of the raw data. This may be useful for debugging.

If early disposition is not possible (i.e., “No” in subprocess 430)—for example, because the tuple of the transport session 325 does not match a rule of the early classifier—a full classifier is executed in subprocess 450. In an embodiment, full classification in subprocess 450 comprises executing a plurality of registered software plugins on the data in the encapsulation layer, currently under consideration, of the transport session 325. Each plugin implements a protocol handler that is configured to determine whether or not the encapsulation layer represents a particular protocol. Plugins may be registered for each supported protocol and/or each protocol that is licensed by an administrator of network 200. As new protocols become supported or licensed, the plugin for the new protocol may be registered with the full classifier. For example, a discrete plugin may be defined for each of TDS, Oracle™, Db2™, MySQL™, TLS, Mongo™, HANA™, PostgreSQL, SQL Server™ and/or the like.

In an embodiment, the classification engine may maintain an iterator that iterates over the message stream of the current encapsulation layer of the current transport session 325. Each plugin may operate on private copies of the iterator. A plugin may treat its private copy of the iterator in any manner it chooses without affecting other plugins. The classification engine's use of this global iterator can guarantee that there is always a certain amount of data available to the plugins (e.g., 512 bytes). It should be understood that this data represents the payload of the encapsulation layer, which may include gap packets for missing packets.

Each plugin will analyze the data and return a response indicating whether or not the data should be classified as the protocol for which the plugin is configured. In other words, a plugin will either “claim” the current encapsulation layer if the data matches the respective protocol or “disclaim” the current encapsulation layer if the data does not match the respective protocol. In an embodiment, each plugin may attempt to extract one or more operations or other characteristics from the data to determine whether or not the data in the current encapsulation layer matches the respective protocol. For example, a plugin may analyze the contents of the encapsulation layer, such as a request and response relationship within the message stream. The plugin may comprise one or more parsers that decode the messages in the message stream and a state machine that validates a sequence of messages or operations (e.g., represented in the messages) that is specific to the protocol corresponding to the plugin.

If the plugin is able to extract the characteristic(s), the data matches the respective protocol, and the plugin claims the current encapsulation layer. Otherwise, if the plugin is unable to extract the characteristic(s), the data does not match the respective protocol, and the plugin disclaims the current encapsulation layer. Each plugin may return a Boolean, with a value of “true” or “1” indicating that the plugin is claiming the current encapsulation layer, and a value of “false” or “0” indicating that the plugin is disclaiming the current encapsulation layer. Alternatively, each plugin could return a trinary value that indicates that either there is a strong match, a weak match, or no match. If a plugin returns a value representing a strong match, the classification engine may immediately classify the encapsulation layer as the protocol associated with the plugin. If a plugin returns a value representing a weak match, the classification engine may defer a determination until after all plugins have returned a value.

If a single plugin claims the encapsulation layer in subprocess 450, the classification engine may classify the encapsulation layer as the protocol associated with that single claiming plugin. If no plugin claims the encapsulation layer in subprocess 450, the classification engine may classify the encapsulation layer into a default class representing a generic protocol or call the blackhole process as the final disposition. If multiple plugins claim the encapsulation layer, the classification engine may apply one or more rules (e.g., based on a priority or order of execution of the plugins) to select one of the plugins and classify the encapsulation layer as the protocol associated with the selected plugin. However, it should be understood that the plugins may be executed successively or defined, such that it is impossible for two plugins to claim the same encapsulation layer. For example, the classification engine may execute the plugins according to a predefined order until one of the plugins claims the encapsulation layer, at which point no more plugins are executed. In any case, the classification engine determines a final disposition or classification in subprocess 460 based on the single or selected plugin that claimed the encapsulation layer.

It should be understood that, in an embodiment which utilizes the trinary values of strong match, weak match, and no match, a plugin that returns a strong match should be selected for the final disposition over any plugin that returns a weak match or no match. As mentioned above, the classification engine may immediately determine the final disposition as soon as any plugin returns a strong match. Thus, an instance of multiple plugins returning a strong match can be avoided. However, if a plugin returns a weak match, the classification engine may defer the determination of a final disposition until all plugins have returned a value. If multiple plugins return a weak match, the classification engine may apply one or more rules to select one of the plugins. If all plugins return no match, the encapsulation layer may be classified into a default class or remain unclassified.

In subprocess 470, the final disposition may be executed. In other words, the data in the encapsulation layer may be handled in accordance with the protocol into which the encapsulation layer was classified in subprocess 460. This final disposition may comprise extracting data 340 from the content or metadata of the encapsulation layer (e.g., according to one or more rules). For example, if the encapsulation layer is classified as TLS or another encryption layer, cryptographic metadata (e.g., certificates and/or cryptographic parameters) may be extracted. The final disposition of an encapsulation layer may be executed by calling a function of the plugin that claimed the encapsulation layer. This function may run through a ruleset to determine how to dispose of the encapsulation layer. This ruleset may be used to redirect some protocols (e.g., to the metrics, blackhole, or dump processes), for example, based on client IP address (e.g., if there is a problem with a specific client) or if a particular protocol is unlicensed by the organization.

In addition, certain protocols may encapsulate one or a plurality of nested encapsulation layers (i.e. “YES” in subprocess 338). In this case, the final disposition 470 may comprise recursively executing subprocess 450 on the data for the nested encapsulation layer. In other words, plugins are executed on the data to classify the nested encapsulation layer. In this case, only plugins corresponding to the set of possible nested protocols may be executed in subprocess 450. In other words, the final disposition of the encapsulating layer may pass a subset of plugins, representing only those protocols which may be nested within the encapsulating layer, as an input to the execution of subprocess 450 for the nested encapsulation layer. Thus, the plugins that need to be executed in subsequent and recursive iterations of subprocess 450 may be narrowed to reduce load on the classification system. As an example, in the event that the plugin for TLS or another cryptographic protocol claims the current encapsulation layer in the current iteration of subprocess 450, the plugins for only those protocols that may be encapsulated within a cryptographic layer may be passed to the recursive iteration of subprocess 450 for the nested encapsulation layer.

In certain cases a protocol may be one of multiple protocols. For example, the TDS protocol may be either Microsoft SQL Server™ or Sybase™. Also, in some cases, the final disposition 470 may comprise, instead of or in addition to extracting data 340, calling the metrics process or the dump process for the encapsulation layer. In still other cases, the final disposition 470 may comprise calling the blackhole process (e.g., if no plugins claim the encapsulation layer), such that no data is extracted from the encapsulation layer, and the encapsulation layer is simply ignored.

To illustrate one typical, non-limiting example of classification, a first iteration of full classification process 334B may begin executing all registered plugins to classify the first encapsulation layer, found in the payload of a TCP transport session. It will be assumed that the plugin for TLS claims the encapsulation layer. Next, this first iteration of full classification process 334B may recursively call a second iteration of full classification process 334 on the nested encapsulation layer within the TLS protocol, to execute only those plugins that correspond to protocols that may be encapsulated within TLS. Assuming the TLS content can be decrypted, this second iteration of full classification process 334 may pass the decrypted content to each of the plugins that correspond to protocols that may be encapsulated within TLS, until one of the plugins claims the second encapsulation layer. For example, the plugin for Oracle™ may claim the second encapsulation layer. Thus, the TCP transport session may be classified as encrypted traffic between a client and an Oracle™ database. In addition, cryptographic metadata may be extracted from the TLS layer, and SQL data may be extracted from the Oracle™ layer. Notably, the resulting tallies for this traffic will be incorporated into data model 350. Thus, an analytic model 360 may infer, from that fact that Oracle™ traffic is flowing between the client and server, that the server is a location of structured data (i.e., an Oracle™ database). In this manner, one or more analytic models 360 can build a data web, describing the locations and flows of structured data.

An example of the execution of a final disposition in subprocess 470 by a TLS classifier plugin will now be described. It will be assumed that the TLS classifier plugin has claimed the current encapsulation layer in subprocess 450. In this case, the classification engine may call a first function in the TLS classifier plugin, which returns a ruleset. The classification engine may follow the returned ruleset to determine whether or not to classify the current encapsulation layer as TLS. Assuming that the ruleset resolves to classification of the current encapsulation layer as TLS, the classification engine classifies the current encapsulation layer as a TLS layer in subprocess 460.

To execute the final disposition in subprocess 470, the classification engine may call a second function in the TLS classifier plugin. This second function may execute a set of routing instructions to determine how to handle the TLS layer. In some cases, the TLS classifier plugin may route the TLS layer directly to the metrics process, for example, if no handshake data is available in the TLS layer. Assuming that this is not the case, the TLS classifier plugin will attempt to decode the handshake data. If the handshake data cannot be decoded, the TLS classifier plugin may route the TLS layer to the metrics process or blackhole process. Otherwise, if the handshake data can be decoded, the TLS classifier plugin may determine whether or not it is possible to decrypt the content of the TLS layer. If the content of the TLS layer cannot be decrypted, the TLS classifier plugin may route the TLS layer to the metrics process or blackhole process. Otherwise, if the content of the TLS layer can be decrypted, the TLS classifier plugin may recursively initiate execution of subprocess 334B to classify the content of the TLS layer. It should be understood that this set of routing instructions is merely illustrative, and that the routing instructions may comprise more complex routing, as well as routing to handle special cases.

The plugins for L7 protocols may follow the same pattern as each other. Each L7 classifier plugin is configured to understand structured data traffic for a specific database protocol, extract context (e.g., username, service name, etc.) from the encapsulation layer, and report operations (e.g., SQL and/or RPC executions) within that context as extracted data 340. For all protocols involving connections to structured data, the routing configuration in the corresponding plugin may be similar. For example, the first time that an SQL or RPC operation is identified in the data, the plugin may use the identified operation to decide whether to keep extracting data 340 from the encapsulation layer or route the encapsulation layer to the metrics process or blackhole process. However, if the plugin decides to route the encapsulation layer to the metrics process or blackhole process, it may defer that decision until certain metadata, such as username and service name, has been extracted from the encapsulation layer. Whenever a plugin fails (e.g., a particular case is not covered by the routing configuration), the encapsulation layer may be routed to the metrics process or blackhole process (e.g., depending on a system setting).

As mentioned above, the TDS protocol may be Sybase™ or SQL Server™. Thus, the TDS classifier plugin may utilize the contents of the encapsulation layer to determine if it is Sybase™ or SQL Server™ protocol. Then, the TDS classifier plugin may utilize a ruleset that is specific to the determined protocol to execute the final disposition in subprocess 470. This same mechanism can be used to override “broken” classifications, which may occur due to the similarity between two protocols. For example, if some network traffic is being classified as Sybase™ in an environment which is known not to contain Sybase™, the ruleset can be adjusted to force this traffic to be disposed of as SQL Server™. Similarly, if only a single client or application is causing misclassification to Sybase™, the ruleset can be adjusted to dispose of all Sybase™ traffic for that specific client or application as SQL Server™ traffic.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
receive a plurality of transport sessions that have been assembled from captured raw packets being transmitted in a network;
for each of the plurality of transport sessions, extract data from each of two or more encapsulation layers in a payload of the transport session;
incorporate the extracted data into a data model of the network, wherein the data model comprises tallies of traffic within the network grouped according to a plurality of dimensions; and
apply one or more analytic models to the data model, wherein at least one of the one or more analytic models utilizes the tallies of traffic to identify structured data stores within the network.

2. The method of claim 1, wherein extracting data from each of two or more encapsulation layers comprises, for each of the two or more encapsulation layers:
classifying the encapsulation layer into a protocol; and
extracting the data from the encapsulation layer based on the protocol.

3. The method of claim 2, wherein, when the protocol is a cryptographic protocol, extracting the data from the encapsulation layer comprises extracting cryptographic metadata from the encapsulation layer.

4. The method of claim 3, wherein the cryptographic metadata comprises a certificate.

5. The method of claim 3, wherein the cryptographic metadata comprises one or more cryptographic parameters.

6. The method of claim 2, wherein the cryptographic metadata is extracted from a handshake of the cryptographic protocol.

7. The method of claim 2, wherein one of the two or more encapsulation layers is nested within another one of the two or more encapsulation layers, and classification of each encapsulation layer into a protocol is performed recursively.

8. The method of claim 2, wherein classifying the encapsulation layer into a protocol comprises:
executing a plurality of plugins that each represent one of a plurality of protocols, wherein each of the plurality of plugins is configured to analyze one or more characteristics of data in the encapsulation layer to determine whether or not the encapsulation layer matches the represented protocol; and
determining the protocol into which the encapsulation layer is classified based on the determinations by the plurality of plugins.

9. The method of claim 8, wherein analyzing one or more characteristics of data in the encapsulation layer comprises parsing messages in a message stream encapsulated by the encapsulation layer according to a state machine to determine whether or not the messages represent a sequence of operations that is specific to the represented protocol.

10. The method of claim 1, wherein extracting data from each of two or more encapsulation layers comprises, for each of the two or more encapsulation layers, if classification of the encapsulation layer into a protocol fails, sending the encapsulation layer to a metrics process that collects one or more measurements.

11. The method of claim 1, wherein each of the tallies of traffic indicate an amount of traffic.

12. The method of claim 1, wherein incorporating the extracted data into the data model comprises folding the extracted data into the data model according to the plurality of dimensions, wherein one of the plurality of dimensions is a time bucket representing a time span.

13. The method of claim 1, wherein the data model represents objects in the network as data structures, and wherein the data structure that represents at least one object comprises an unsure parameter that indicates whether or not a datum in the data structure that represents the at least one object has been inferred.

14. The method of claim 1, wherein at least a subset of the tallies of traffic represent an event.

15. The method of claim 14, wherein the event is a database operation, and wherein the database operation is a Structured Query Language (SQL) statement or a remote procedure call (RPC).

16. The method of claim 1, wherein the one or more analytic models are applied to the data model in real time to detect an attack in progress within at least one of the plurality of transport sessions, and wherein the method further comprises using the at least one hardware processor to block or redirect the attack.

17. The method of claim 1, wherein the one or more analytic models are applied to the data model in real time to detect a violation of a network-level policy within a connection of at least one of the plurality of transport sessions, and wherein the method further comprises using the at least one hardware processor to block or proxy the connection.

18. The method of claim 1, further comprising using the at least one hardware processor to generate a data web that represents the identified structured data stores and data flow to or from the identified structured data stores.

19. A system comprising:
at least one hardware processor; and
one or more software modules that are configured to, when executed by the at least one hardware processor,
receive a plurality of transport sessions that have been assembled from captured raw packets being transmitted in a network,
for each of the plurality of transport sessions, extract data from each of two or more encapsulation layers in a payload of the transport session,
incorporate the extracted data into a data model of the network, wherein the data model comprises tallies of traffic within the network grouped according to a plurality of dimensions, and
apply one or more analytic models to the data model, wherein at least one of the one or more analytic models utilizes the tallies of traffic to identify structured data stores within the network.

20. A non-transitory computer-readable medium having instructions stored therein, wherein the instructions, when executed by a processor, cause the processor to:
receive a plurality of transport sessions that have been assembled from captured raw packets being transmitted in a network;
for each of the plurality of transport sessions, extract data from each of two or more encapsulation layers in a payload of the transport session;
incorporate the extracted data into a data model of the network, wherein the data model comprises tallies of traffic within the network grouped according to a plurality of dimensions; and
apply one or more analytic models to the data model, wherein at least one of the one or more analytic models utilizes the tallies of traffic to identify structured data stores within the network.

21. A method comprising using at least one hardware processor to:
receive a plurality of transport sessions that have been assembled from captured raw packets being transmitted in a network;
for each of the plurality of transport sessions,
for a cryptographic encapsulation layer, classify the cryptographic encapsulation layer into a cryptographic protocol, and extract cryptographic metadata from the cryptographic encapsulation layer, wherein the cryptographic metadata comprises at least one of a certificate or one or more cryptographic parameters, and,
for at least one nested encapsulation layer that is encapsulated within the cryptographic encapsulation layer, classify the nested encapsulation layer, and extract data from the nested encapsulation layer;
incorporate the extracted cryptographic metadata from the cryptographic encapsulation layer and the extracted data from the nested encapsulation layer into a data model of the network, wherein the data model comprises tallies of traffic within the network grouped according to a plurality of dimensions;
apply one or more analytic models to the data model, wherein at least one of the one or more analytic models utilizes the tallies of traffic to identify structured data stores within the network; and
generate a data web that represents the identified structured data stores and data flow to or from the identified data stores.
